(19) United States
(12) Patent Application Publication
(10) Pub. No.: US 2025/0006910 A1
(43) Pub. Date: Jan. 2, 2025

(54) Anode Material and a Preparation Method therefor, and a Battery

(71) Applicant: BTR NEW MATERIAL GROUP CO., LTD., Shenzhen, Guangdong (CN)

(72) Inventors: Peng HE, Shenzhen, Guangdong (CN); Jianguo REN, Shenzhen, Guangdong (CN); Xueqin HE, Shenzhen, Guangdong (CN); Eming GUO, Shenzhen, Guangdong (CN)

(21) Appl. No.: 18/705,520

(22) PCT Filed: May 16, 2023
(86) PCT No.: PCT/CN2023/094432

§ 371 Date: Apr. 26, 2024

(30) Foreign Application Priority Data
Jun. 30, 2022 (CN) 202210777486.4

(51) Int. Cl. H01M 4/38; H01M 4/02; H01M 4/04; H01M 4/36; H01M 4/583

(52) U.S. Cl. CPC H01M 4/386; H01M 4/0421; H01M 4/366; H01M 4/583; H01M 2004/021; H01M 2004/027

(57) ABSTRACT

The present disclosure provides an anode material and a preparation method therefor, and a battery. The anode material includes a first silicon material layer, and a buffer layer, a second silicon material layer, and a coating layer, which are sequentially arranged on a surface of the first silicon material layer. The density of the first silicon material layer is less than the density of the second silicon material layer. The anode material of the present disclosure has controllable volume expansion, a stable electrolyte solution interface, and high reversible capacity.

### CROSS-REFERENCE TO RELATED APPLICATION

The present application is a National Stage of International Patent Application No: PCT/CN2023/094432 filed on May 16, 2023, which claims the benefit of priority to Chinese patent application No. 202210777486.4 filed to the China National Intellectual Property Administration on Jun. 30, 2022 and entitled “Silicon-Based Composite Material and Battery”, the disclosure of which is hereby incorporated by reference in its entirety.

### TECHNICAL FIELD

The present disclosure relates to the technical field of new energy materials, in particular, to an anode material and a preparation method therefor, and a battery.

### BACKGROUND

Lithium ion batteries are widely applied to the fields such as portable devices, grid energy storage, electric vehicles, etc. The graphite anode theoretical capacity used by conventional lithium ion batteries is 372 mAh/g, and current technologies are approaching the engineering ultimate capacity of the lithium ion batteries. In recent years, the rapid development of electric vehicles and the growing demand for higher energy density lithium ion batteries have urged researchers to search for battery materials with higher energy density and better cycle performance. A silicon material has higher theoretical capacity (3579 mAh/g), is one of the key materials to further improve the energy density of the lithium ion batteries, and is expected to replace graphite as the next generation of battery anode materials. However, silicon undergoes large volume changes during a lithiation/de-lithiation process, causing fragmentation, pulverization, and detachment of an anode material from a current collector, and continued growth of a Solid Electrolyte Interface (SEI) film, ultimately leading to battery capacity decay. Therefore, in order to relieve adverse effects of the silicon material due to volume expansion during charging and discharging, it is necessary to provide a battery material with high capacity and long cycle life through rational battery material design.

In order to solve the above problems, common methods include: 1) introducing some inactive substances to attenuate a volume expansion effect caused by silicon, such as a silicon alloy material; 2) adjusting the particle size of the silicon, for example, selecting silicon nanoparticles less than 150 nm, silicon nanowires less than 70 nm, and silicon nanofilms less than 33 nm, where under these critical sizes, silicon nanostructures maintain stable during lithiation, such that a volume effect caused by expansion may be relieved; and 3) using a composite material such as a silicon-based anode material. However, although nanoscale design of the silicon material may effectively improve its volume expansion, the silicon material is high in preparation cost and cumbersome in step, such that it is difficult to commercialize the silicon material for large-scale applications; and the high specific surface area of a silicon nanomaterial consumes an excessive amount of an electrolyte solution and the material has low first coulombic efficiency, leading to irreversible capacity loss. Although the silicon-based anode material may effectively decrease the specific surface area of the electrode material and reduce unnecessary electrolyte solution reactions, the conductivity of the material, as well as the degree of restriction on the expansion effect of the material, needs to be improved. In addition, existing silicon-based anode material technologies are not mature yet. Common silicon-carbon materials are simple physical mixture of graphite and nanosilicon materials, which are difficult to form a relatively-homogeneous material distribution, and do not take the compatibility of the morphology and size of the nanosilicon material and the graphite into consideration, thus the silicon-carbon materials have not yet reached the desired electrochemical performance. Therefore, although commercial batteries are now beginning to carry silicon-containing anode materials, and the content of silicon is generally within 10%, in order to further increase the silicon capacity of the anode material, increase the energy density of the batteries, and effectively relieve the expansion effect of the silicon, a composite mode of the silicon-based anode material needs to be rationally designed to comprehensively optimize the electrochemical performance of the anode material.

### SUMMARY

In view of the above problems in the prior art, the present disclosure is intended to provide an anode material and a preparation method therefor, and a battery. The anode material of the present disclosure has controllable volume expansion, a stable electrolyte solution interface, and high reversible capacity.

According to a first aspect, the present disclosure provides an anode material. The anode material includes: a first silicon material layer; and a buffer layer, a second silicon material layer, and a coating layer, which are sequentially arranged on a surface of the first silicon material layer.

The density of the first silicon material layer is less than the density of the second silicon material layer.

The anode material further includes a porous substrate material. The first silicon material layer is located on a surface of the porous substrate material, and the buffer layer, the second silicon material layer, and the coating layer are sequentially arranged on the surface of the first silicon material layer.

In some implementations, the density of the first silicon material layer is 1.9 g/cm³-2.1 g/cm³.

In some implementations, the density of the second silicon material layer is 2.1 g/cm³-2.3 g/cm³.

In some implementations, the thickness of the first silicon material layer is 20%-40% of a total thickness of the first silicon material layer, the buffer layer, the second silicon material layer, and the coating layer.

In some implementations, the thickness of the second silicon material layer is 10%-20% of a total thickness of the first silicon material layer, the buffer layer, the second silicon material layer, and the coating layer.

In some implementations, the thickness of the buffer layer is 20%-40% of a total thickness of the first silicon material layer, the buffer layer, the second silicon material layer, and the coating layer.

In some implementations, the thickness of the coating layer is 10%-20% of a total thickness of the first silicon material layer, the buffer layer, the second silicon material layer, and the coating layer.

In some implementations, the thickness of the first silicon material layer is 0.01 μm-5 μm.

In some implementations, the thickness of the second silicon material layer is 0.01 μm-1 μm.

In some implementations, the thickness of the buffer layer is 0.01 μm-5 μm.

In some implementations, the thickness of the coating layer is 0.01 μm-1 μm.

In some implementations, the mass of silicon in the first silicon material layer accounts for 90.00%-99.99% of the mass of the first silicon material layer.

In some implementations, the mass of hydrogen in the first silicon material layer accounts for 0.01%-10% of the mass of the first silicon material layer.

In some implementations, the mass of silicon in the second silicon material layer accounts for 90.00%-99.99% of the mass of the second silicon material layer.

In some implementations, the mass of hydrogen in the second silicon material layer accounts for 0.01%-10% of the mass of the second silicon material layer.

In some implementations, the first silicon material layer includes at least one of amorphous silicon and crystalline silicon.

In some implementations, the buffer layer includes amorphous carbon.

In some implementations, the buffer layer includes a metallic oxide, and the metallic oxide includes at least one of titanium oxide, silicon oxide, and aluminum oxide.

In some implementations, the buffer layer includes metal, and the metal includes at least one of tin and copper.

In some implementations, the buffer layer includes a nitride, and the nitride includes at least one of silicon nitride, aluminum nitride, titanium nitride, and tantalum nitride.

In some implementations, the buffer layer includes a flexible polymer, and the flexible polymer includes at least one of polyolefin and derivatives thereof, poly(vinyl alcohol) and derivatives thereof, poly(acrylic acid) and derivatives thereof, polyamide and derivatives thereof, carboxymethyl cellulose and derivatives thereof, and alginic acid and derivatives thereof.

In some implementations, the second silicon material layer includes at least one of amorphous silicon and crystalline silicon.

In some implementations, the coating layer includes amorphous carbon.

In some implementations, the coating layer includes a metallic oxide, and the metallic oxide includes at least one of titanium oxide, silicon oxide, and aluminum oxide.

In some implementations, the coating layer includes metal, and the metal includes at least one of tin and copper.

In some implementations, the coating layer includes a nitride, and the nitride includes at least one of silicon nitride, aluminum nitride, titanium nitride, and tantalum nitride.

In some implementations, the coating layer includes a flexible polymer, and the flexible polymer includes at least one of polyolefin and derivatives thereof, poly(vinyl alcohol) and derivatives thereof, poly(acrylic acid) and derivatives thereof, polyamide and derivatives thereof, carboxymethyl cellulose and derivatives thereof, and alginic acid and derivatives thereof.

In some implementations, the first silicon material layer is provided with pores.

In some implementations, the first silicon material layer is provided with the pores, and the porosity of the first silicon material layer is 1%-40%.

In some implementations, the first silicon material layer is provided with the pores, and the pores of the first silicon material layer have an aperture size being 5 nm-100 nm.

In some implementations, the first silicon material layer is provided with the pores, and the first silicon material layer has a pore volume being 0.01 cm³/g-0.5 cm³/g.

In some implementations, at least partial buffer material in the buffer layer is filled in the pores of the first silicon material layer.

In some implementations, the anode material is provided with a pore structure.

In some implementations, the anode material is provided with the pore structure, and the pore structure includes micropores, mesopores and macropores.

In some implementations, the anode material is provided with the pore structure, and the pore structure includes the micropores, the mesopores and the macropores. A volume proportion of the micropores in the pore structure is greater than 70%, a volume proportion of the mesopores in the pore structure is greater than 20%, and a volume proportion of the macropores in the pore structure is less than 10%.

In some implementations, the anode material is provided with the pore structure, and the pore structure has a pore volume being 0.001 cm³/g-0.1 cm³/g.

In some implementations, the tap density of the anode material is 0.5 cm³/g-1.5 cm³/g.

In some implementations, the specific surface area of the anode material is 5 m²/g-30 m²/g.

In some implementations, the anode material further includes a porous substrate material, and a first silicon material layer located at least partial surface of the porous substrate material.

In some implementations, the porosity of the porous substrate material is 40%-60%.

In some implementations, the specific surface area of the porous substrate material is 50 m²/g-2500 m²/g.

In some implementations, the particle size of the porous substrate material is 5 nm-20 nm.

In some implementations, the aperture size of the porous substrate material is 5 nm-100 nm.

In some implementations, the pore capacity of the porous substrate material is 0.01 cm³/g-1.8 cm³/g.

In some implementations, the porous substrate material includes at least one of porous carbon and a porous organic framework.

In some implementations, the porous substrate material is a conductive material.

In some implementations, at least part of the first silicon material layer is filled in a pore structure of the porous substrate material.

In some implementations, a filling rate of the pore structure of the porous substrate material is 40%-80%.

According to a second aspect, the present disclosure provides a method for preparing an anode material. The preparation method includes the following steps;

A first silicon material layer is provided.

A buffer layer is formed on at least partial surface of the first silicon material layer.

A second silicon material layer is formed on at least partial surface of the buffer layer.

A coating layer is formed on at least partial surface of the second silicon material layer.

The density of the first silicon material layer is less than the density of the second silicon material layer.

In some implementations, the method for preparing an anode material further includes providing a porous substrate material, and forming a first silicon material layer on at least partial surface of the porous substrate material.

A buffer layer is formed on at least partial surface of the first silicon material layer.

A second silicon material layer is formed on at least partial surface of the buffer layer.

A coating layer is formed on at least partial surface of the second silicon material layer.

The density of the first silicon material layer is less than the density of the second silicon material layer.

In some implementations, at least one of the first silicon material layer, the buffer layer, the second silicon material layer, or the coating layer is formed by using a vapor deposition method.

In some implementations, a deposition temperature for forming the first silicon material layer formed by using the vapor deposition method is less than a deposition temperature for forming the second silicon material layer.

In some implementations, the deposition temperature for forming the first silicon material layer and the second silicon material layer by using the vapor deposition method is 400° C.-800° C.

In some implementations, deposition time for forming the first silicon material layer and the second silicon material layer by using the vapor deposition method is 2 h-6 h.

In some implementations, the step of forming the first silicon material layer and the second silicon material layer by using the vapor deposition method further includes introducing a gas phase silicon source.

In some implementations, the step of forming the first silicon material layer and the second silicon material layer by using the vapor deposition method further includes introducing the gas phase silicon source. A total flow rate of the gas phase silicon source is 100 sccm-500 sccm.

In some implementations, the step of forming the first silicon material layer and the second silicon material layer by using the vapor deposition method further includes introducing the gas phase silicon source and an inert carrier gas.

In some implementations, the step of forming the first silicon material layer and the second silicon material layer by using the vapor deposition method further includes introducing the gas phase silicon source and the inert carrier gas. The inert carrier gas includes at least one of nitrogen, argon, and helium.

In some implementations, the step of forming the first silicon material layer and the second silicon material layer by using the vapor deposition method further includes introducing the gas phase silicon source and the inert carrier gas. A total flow rate of the gas phase silicon source and the inert carrier gas is 100 sccm-500 sccm.

In some implementations, the step of forming the first silicon material layer and the second silicon material layer by using the vapor deposition method further includes introducing the gas phase silicon source and the inert carrier gas. A volume proportion of the gas phase silicon source in a gas is 5%-100%.

In some implementations, the step of forming the first silicon material layer by using the vapor deposition method further includes introducing a dopant gas.

In some implementations, the step of forming the first silicon material layer by using the vapor deposition method further includes introducing the dopant gas. The dopant gas may be NH₃ or PH₃.

In some implementations, the step of forming the first silicon material layer and the second silicon material layer by using the vapor deposition method further includes introducing the gas phase silicon source and the inert carrier gas. The gas phase silicon source includes at least one of silane, disilane, trisilane, and tetrasilane.

In some implementations, the step of forming the first silicon material layer and the second silicon material layer by using the vapor deposition method specifically includes using plasma to enhance the vapor deposition method for vapor deposition.

In some implementations, a deposition temperature for forming the buffer layer by using the vapor deposition method is 450° C.-800° C.

In some implementations, deposition time for forming the buffer layer by using the vapor deposition method is 0.5 h-3 h.

In some implementations, the step of forming the buffer layer by using the vapor deposition method further includes introducing a gas phase carbon source.

In some implementations, the step of forming the buffer layer by using the vapor deposition method further includes introducing the gas phase carbon source. A total flow rate of the gas phase carbon source is 100 sccm-500 sccm.

In some implementations, the step of forming the buffer layer by using the vapor deposition method further includes introducing the gas phase carbon source and an inert carrier gas.

In some implementations, the step of forming the buffer layer by using the vapor deposition method further includes introducing the gas phase carbon source and the inert carrier gas. The inert carrier gas includes at least one of nitrogen, argon, and helium.

In some implementations, the step of forming the buffer layer by using the vapor deposition method further includes introducing the gas phase carbon source and the inert carrier gas. A total flow rate of the gas phase carbon source and the inert carrier gas is 100 sccm-500 sccm.

In some implementations, the step of forming the buffer layer by using the vapor deposition method further includes introducing the gas phase carbon source and the inert carrier gas. A volume ratio of the gas phase carbon source to the inert carrier gas is 1:(1-10).

In some implementations, the step of forming the buffer layer by using the vapor deposition method further includes introducing the gas phase carbon source and the inert carrier gas. The gas phase carbon source includes any one or a combination of at least two of methane, ethane, propane, ethylene, acetylene, gaseous benzene, gaseous toluene, gaseous xylene, gaseous ethanol, and gaseous acetone.

In some implementations, the step of forming the buffer layer by using the vapor deposition method further includes filling at least partial carbon material formed through the cracking of the gas phase carbon source in pores of the first silicon material layer.

In some implementations, a deposition temperature for forming the coating layer by using the vapor deposition method is 400° C.-800° C.

In some implementations, deposition time for forming the coating layer by using the vapor deposition method is 0.5 h-3 h.

In some implementations, the step of forming the coating layer by using the vapor deposition method further includes introducing a gas phase carbon source.

In some implementations, the step of forming the coating layer by using the vapor deposition method further includes introducing the gas phase carbon source. A total flow rate of the gas phase carbon source is 100 sccm-500 sccm.

In some implementations, the step of forming the coating layer by using the vapor deposition method further includes introducing the gas phase carbon source and an inert carrier gas.

In some implementations, the step of forming the buffer layer by using the vapor deposition method further includes introducing the gas phase carbon source and the inert carrier gas. The inert carrier gas includes at least one of nitrogen, argon, and helium.

In some implementations, the step of forming the coating layer by using the vapor deposition method further includes introducing the gas phase carbon source and the inert carrier gas. A total flow rate of the gas phase carbon source and the inert carrier gas is 100 sccm-500 sccm.

In some implementations, the step of forming the coating layer by using the vapor deposition method further includes introducing the gas phase carbon source and the inert carrier gas. A volume ratio of the gas phase carbon source to the inert carrier gas is 1:(1-10).

In some implementations, the step of forming the coating layer by using the vapor deposition method further includes introducing the gas phase carbon source and the inert carrier gas. The gas phase carbon source includes any one or a combination of at least two of methane, ethane, propane, ethylene, acetylene, gaseous benzene, gaseous toluene, gaseous xylene, gaseous ethanol, and gaseous acetone.

In some implementations, the step of forming the coating layer by using the vapor deposition method further includes filling at least partial carbon material formed through the cracking of the gas phase carbon source in pores of the second silicon material layer.

In some implementations, the step of forming the buffer layer and the coating layer by using the vapor deposition method specifically includes using plasma to enhance the vapor deposition method for vapor deposition.

In some implementations, a first silicon material and a buffer layer raw material are mixed in a solvent, and then drying and curing are performed to form the buffer layer on the at least partial surface of the first silicon material layer.

In some implementations, a substance after the first silicon material layer is formed and a buffer layer raw material are mixed in a solvent, and then drying and curing are performed to form the buffer layer on the at least partial surface of the first silicon material layer.

In some implementations, the buffer layer raw material includes at least one of a carbon material, a metallic oxide, a conductive polymer material, and a nitride.

In some implementations, the buffer layer raw material includes the carbon material, and the carbon material includes at least one of soft carbon, hard carbon, crystalline carbon, and amorphous carbon.

In some implementations, the buffer layer raw material includes the metallic oxide, and the metallic oxide includes at least one of titanium oxide, aluminum oxide, lithium oxide, cobalt oxide, and vanadium oxide.

In some implementations, the buffer layer raw material includes a conductive polymer, and the conductive polymer includes at least one of polyaniline, polyacetylene, polypyrrole, polythiophene, poly(3-hexylthiophene), poly(para-styrene), polypyridine, or poly(phenylene ethylene).

In some implementations, the buffer layer raw material includes the nitride, and the nitride includes at least one of titanium nitride, vanadium nitride, cobalt nitride, nickel nitride, or carbon nitride.

In some implementations, a temperature of drying and curing is 80° C.-150° C., and temperature-holding time for drying and curing is 1 h-12 h.

In some implementations, after the substance after the first silicon material layer is formed and the buffer layer raw material are mixed in the solvent, and then drying and curing are performed, the method further includes performing heat treatment on dried and cured products. A temperature of the heat treatment is 400° C.-900° C., and temperature-holding time for the heat treatment is 1 h-12 h.

In some implementations, a substance after the second silicon material layer is formed and a coating layer raw material are mixed in a solvent, and then drying and curing are performed to form the coating layer on the at least partial surface of the second silicon material layer.

In some implementations, the coating layer raw material includes at least one of a carbon material, a metallic oxide, a conductive polymer material, and a nitride.

In some implementations, the coating layer raw material includes the carbon material, and the carbon material includes at least one of soft carbon, hard carbon, crystalline carbon, or amorphous carbon.

In some implementations, the coating layer raw material includes the metallic oxide, and the metallic oxide includes at least one of titanium oxide, aluminum oxide, lithium oxide, cobalt oxide, and vanadium oxide.

In some implementations, the coating layer raw material includes a conductive polymer, and the conductive polymer includes at least one of polyaniline, polyacetylene, polypyrrole, polythiophene, poly(3-hexylthiophene), poly(para-styrene), polypyridine, or poly(phenylene ethylene).

In some implementations, the coating layer raw material includes the nitride, and the nitride includes at least one of titanium nitride, vanadium nitride, cobalt nitride, nickel nitride, and carbon nitride.

In some implementations, a temperature of drying and curing is 80° C.-150° C., and temperature-holding time for drying and curing is 1 h-12 h.

In some implementations, after the substance after the second silicon material layer is formed and the coating layer raw material are mixed in the solvent, and then drying and curing are performed, the method further includes performing heat treatment on dried and cured products. A temperature of the heat treatment is 400° C.-900° C., and temperature-holding time for the heat treatment is 1 h-12 h.

According to a third aspect, the present disclosure provides a battery, including the anode material or an anode material prepared by the method for preparing an anode material.

The first silicon material layer in the anode material provided in the present disclosure is low in density, and has a fluffy structure that may cope with stress changes caused by the expansion of the anode material, such that the structural stability of the anode material is maintained. The second silicon material layer is high in density, and has a dense morphological structure that may better prevent an electrolyte solution from further reacting with inner layer substances, such that the formation of an SEI film is reduced, and the cycle stability of the material is improved. The buffer layer wraps the first silicon material layer, and can fill the pores of the first silicon material layer to increase the volume capacity of the anode material. The coating layer may reduce direct contact between the anode material and the electrolyte solution to decrease the specific surface area of anode material particles, such that the rate performance of the anode material is improved. The anode material that has controllable volume expansion, a stable electrolyte solution interface, and high reversible capacity can be obtained by sequentially arranging multilayer structures on the surface of the first silicon material layer.

### BRIEF DESCRIPTION OF THE DRAWINGS

FIG. 1 is a schematic structural diagram of an anode material according to an implementation of the present disclosure.

FIG. 2 is another schematic structural diagram of an anode material according to an implementation of the present disclosure.

FIG. 3 is a schematic flow chart of a method for preparing an anode material according to an implementation of the present disclosure.

FIG. 4 is another schematic flow chart of a method for preparing an anode material according to an implementation of the present disclosure.

Wherein, 1, 2, 3, 4 and 5 in the above figures represent as follows:

1: First silicon material layer; 2: Buffer layer; 3: Second silicon material layer; 4: Coating layer; 5: Substrate material.

### DETAILED DESCRIPTION OF THE EMBODIMENTS

In order to make the objectives, technical solutions and effects of the present disclosure clearer and more explicit, the present disclosure is further described in detail below with reference to the drawings and embodiments.

It is to be clear that the described embodiments are only part of the embodiments of the present disclosure, not all the embodiments. All other embodiments obtained by those of ordinary skill in the art on the basis of the embodiments in the present disclosure without creative work fall within the scope of protection of the present disclosure.

The terms used in the embodiments of the present disclosure are only for describing specific embodiments and are not intended to limit the present disclosure. Singular forms “a/an”, “said”, and “the” used in the embodiments and appended claims of the present disclosure are also intended to include plural forms unless other meanings are clearly expressed in the context.

It is to be understood that, the term “and/or” used here is merely an association relationship describing related objects, which means that there may be three relationships, for example, A and/or B may indicate three cases: A exists alone, A and B exist simultaneously, and B exists alone. In addition, the character “/” in this paper generally indicates that the related objects are in an “or” relationship.

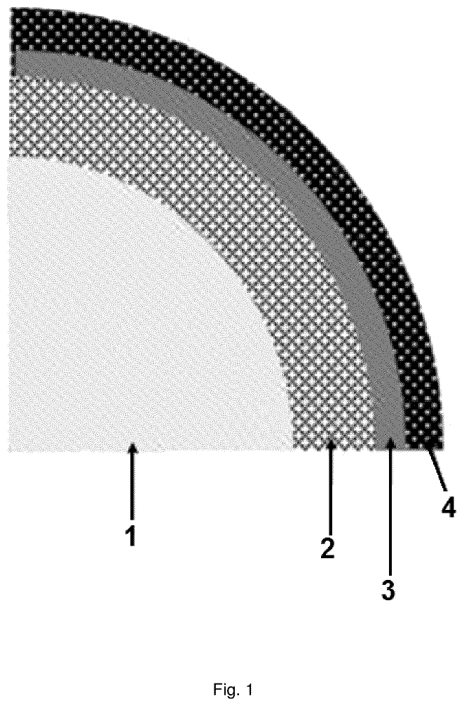

The present disclosure provides an anode material. As shown in FIG. 1, the anode material includes: a first silicon material layer; and a buffer layer, a second silicon material layer, and a coating layer, which are sequentially arranged on a surface of the first silicon material layer.

Wherein, the density of the first silicon material layer is less than the density of the second silicon material layer.

The first silicon material layer and the second silicon material layer in the anode material provided in the present disclosure have different densities. The first silicon material layer is low in density, and has a fluffy structure compared with the second silicon material layer, which may cope with stress changes caused by the expansion of the anode material, such that the structural stability of the anode material is maintained. The second silicon material layer is high in density, and has a dense morphological structure that may better prevent an electrolyte solution from further reacting with an inner layer first silicon material on the basis of maximizing the capacity of the material, such that the formation of an SEI film is reduced, and the cycle stability of the material is improved. In addition, the conductivity of the second silicon material layer with high density is higher than that of the first silicon material layer with low density, such that the conductivity of the material is improved. The first silicon material layer and the second silicon material layer having different densities may act synergistically to increase the capacity of the material together, and under the common action of the buffer layer, an active material is prevented from being mechanically pulverized during a cycle process. The buffer layer wraps the first silicon material layer, and can fill the pores of the first silicon material layer to increase the volume capacity of the anode material and improve the structural stability of the material, so as to relieve volume expansion due to large stress changes in a silicon material during a lithium alloying reaction. The coating layer may reduce direct contact between the anode material and the electrolyte solution to decrease the specific surface area of anode material particles, such that the rate performance of the anode material is improved. The anode material that has controllable volume expansion, a stable electrolyte solution interface, and high reversible capacity can be obtained by arranging multilayer structures.

In some implementations, a first silicon material includes at least one of amorphous silicon or crystalline silicon. Preferably, the first silicon material is the amorphous silicon. The amorphous silicon material has an amorphous structure, which may effectively prevent the silicon material from being pulverized, such that mechanical failure of the silicon material is reduced, and the cycle life of the anode material can also be prolonged.

In another implementation, the first silicon material layer includes the crystalline silicon. In other implementations, the first silicon material layer may further include a mixed material of the amorphous silicon and the crystalline silicon, and is not limited herein.

In some implementations, the density of the first silicon material layer is 1.9 g/cm³-2.1 g/cm³, may specifically be 1.9 g/cm³, 1.91 g/cm³, 1.92 g/cm³, 1.93 g/cm³, 1.94 g/cm³, 1.95 g/cm³, 1.99 g/cm³, 2.0 g/cm³, 2.04 g/cm³, 2.08 g/cm³, 2.1 g/cm³, or the like, or may definitely be other numerical values within the range of 1.9 g/cm³-2.1 g/cm³, which is not limited herein.

In some implementations, the thickness of the first silicon material layer is 20%-40% of a total thickness of the first silicon material layer, the buffer layer, the second silicon material layer, and the coating layer, may specifically be 20%, 25%, 30%, 35%, 36%, 37%, 38%, 39%, 40%, or the like, or may definitely be other numerical values within the above range, which is not limited herein, and preferably, 30-40%.

In some implementations, the thickness of the first silicon material layer is 0.01 μm-5 μm, may specifically be 0.01 μm, 0.1 μm, 0.5 μm, 1 μm, 1.5 μm, 2 μm, 2.5 μm, 3 μm, 3.5 μm, 4 μm, 4.5 μm, 5 μm, or the like, or may definitely be other numerical values within the above range, which is not limited herein.

In some implementations, the mass of silicon in the first silicon material layer accounts for 90.00%-99.99% of the mass of the first silicon material layer, may specifically account for 90.00%, 91.00%, 92.00%, 93.00%, 94.00%, 95.00%, 96.00%, 97.00%, 98.00%, 99.00%, 99.99%, or the like, or may definitely be other numerical values within the above range, which is not limited herein.

In some implementations, the mass of hydrogen in the first silicon material layer accounts for 0.01%-10% of the mass of the first silicon material layer, may specifically account for 0.01%, 0.05%, 0.1%, 1%, 1.5%, 2%, 3%, 4.5%, 5%, 5.5%, 6%, 7%, 8%, 9%, 10%, or the like, or may definitely be other numerical values within the above range, which is not limited herein.

In some implementations, the first silicon material layer is provided with pores.

In some implementations, the porosity of the first silicon material layer is 1%-40%, may specifically be 1%, 5%, 10%, 15%, 20%, 25%, 30%, 35%, 40%, or the like, or may definitely be other values within the above range, which is not limited herein.

In some implementations, the pores of the first silicon material layer have an aperture size being 5 nm-100 nm, may specifically be 5 nm, 10 nm, 20 nm, 25 nm, 30 nm, 40 nm, 50 nm, 60 nm, 70 nm, 80 nm, 90 nm, 100 nm, or the like, or may definitely be other numerical values within the above range, which is not limited herein.

In some implementations, the first silicon material layer has a pore volume being 0.01 cm³/g-0.5 cm³/g, may specifically be 0.01 cm³/g, 0.05 cm³/g, 0.1 cm³/g, 0.2 cm³/g, 0.3 cm³/g, 0.4 cm³/g, 0.5 cm³/g, or the like, and definitely, or may definitely be other numerical values within the above range, which is not limited herein.

In some implementations, at least partial buffer material in the buffer layer is filled in the pores of the first silicon material layer, such that the pores of the first silicon material layer may be further filled to improve the conductivity and rate performance of the anode material are improved.

In some implementations, the buffer layer includes amorphous carbon.

In some implementations, the buffer layer includes a metallic oxide, and the metallic oxide includes at least one of titanium oxide, silicon oxide, and aluminum oxide.

In some implementations, the buffer layer includes metal, and the metal includes at least one of tin and copper.

In some implementations, the buffer layer includes a nitride, and the nitride includes at least one of silicon nitride, aluminum nitride, titanium nitride, and tantalum nitride.

In some implementations, the buffer layer includes a flexible polymer, and the flexible polymer includes at least one of polyolefin and derivatives thereof, poly(vinyl alcohol) and derivatives thereof, poly(acrylic acid) and derivatives thereof, polyamide and derivatives thereof, carboxymethyl cellulose and derivatives thereof, and alginic acid and derivatives thereof.

The buffer layer is located on the surface of the first silicon material layer, such that the first silicon material layer is wrapped by a buffer layer material, so as to effectively protect the first silicon material layer. Similarly, the second silicon material layer is wrapped by the buffer layer and the coating layer to form a sandwich-like structure, so as to protect the second silicon material layer.

In some implementations, the thickness of the buffer layer is 20%-40% of a total thickness of the first silicon material layer, the buffer layer, the second silicon material layer, and the coating layer, may specifically be 20%, 25%, 30%, 35%, 36%, 37%, 38%, 39%, 40%, or the like, or may definitely be other numerical values within the above range, which is not limited herein.

In some implementations, the thickness of the buffer layer is 0.01 μm-5 μm, may specifically be 0.01 μm, 0.05 μm, 0.1 μm, 0.5 μm, 1 μm, 1.5 μm, 2 μm, 2.5 μm, 3 μm, 3.5 μm, 4 μm, 4.5 μm, 4.6 μm, 5 μm, or the like, or may definitely be other numerical values within the above range, which is not limited herein.

In some implementations, the second silicon material layer includes at least one of amorphous silicon or crystalline silicon. The density of the second silicon material layer is higher than that of the first silicon material layer. A relatively-dense morphological structure of the second silicon material layer may better prevent an electrolyte solution from further reacting with inner layer substances, such that the formation of an SEI film is reduced, and the cycle stability of the anode material is improved.

In an implementation, the second silicon material layer may include an amorphous silicon layer, may also include a crystalline silicon layer, or may also include a crystalline silicon or amorphous silicon mixed layer, and is not limited herein.

In some embodiments, the density of the second silicon material layer is 2.1 g/cm³-2.3 g/cm³, may specifically be 2.1 g/cm³, 2.15 g/cm³, 2.2 g/cm³, 2.25 g/cm³, 2.26 g/cm³, 2.27 g/cm³, 2.28 g/cm³, 2.29 g/cm³, 2.3 g/cm³, or the like, or may definitely be other numerical values within the range of 2.1 g/cm³-2.3 g/cm³, which is not limited herein.

In some implementations, the thickness of the second silicon material layer is 10%-20% of a total thickness of the first silicon material layer, the buffer layer, the second silicon material layer, and the coating layer, may specifically be 10%, 11%, 12%, 13%, 14%, 15%, 16%, 17%, 18%, 19%, 20%, or the like, or may definitely be other numerical values within the above range, which is not limited herein.

In some implementations, the thickness of the second silicon material layer is 0.01 μm-1 μm, may specifically be 0.01 μm, 0.05 μm, 0.1 μm, 0.2 μm, 0.3 μm, 0.4 μm, 0.5 μm, 0.6 μm, 0.7 μm, 0.8 μm, 0.9 μm, 1 μm, or the like, or may definitely be other numerical values within the above range, which is not limited herein.

In some implementations, the mass of silicon in the second silicon material layer accounts for 90.00%-99.99% of the mass of the second silicon material layer, may specifically account for 90.00%, 91.00%, 92.00%, 93.00%, 94.00%, 95.00%, 96.00%, 97.00%, 98.00%, 99.00%, 99.99%, or the like, or may definitely be other numerical values within the above range, which is not limited herein.

In some implementations, the mass of hydrogen in the second silicon material layer accounts for 0.01%-10% of the mass of the second silicon material layer, may specifically account for 0.01%, 0.05%, 0.1%, 1%, 1.5%, 2%, 3%, 4.5%, 5%, 5.5%, 6%, 7%, 8%, 9%, 10%, or the like, or may definitely be other numerical values within the above range, which is not limited herein.

In some implementations, the coating layer includes amorphous carbon.

In some implementations, the coating layer includes a metallic oxide, and the metallic oxide includes at least one of titanium oxide, silicon oxide, and aluminum oxide.

In some implementations, the coating layer includes metal, and the metal includes at least one of tin and copper.

In some implementations, the coating layer includes a nitride, and the nitride includes at least one of silicon nitride, aluminum nitride, titanium nitride, and tantalum nitride.

In some implementations, the coating layer includes a flexible polymer, and the flexible polymer includes at least one of polyolefin and derivatives thereof, poly(vinyl alcohol) and derivatives thereof, poly(acrylic acid) and derivatives thereof, polyamide and derivatives thereof, carboxymethyl cellulose and derivatives thereof, and alginic acid and derivatives thereof.

It is understandable that, the coating layer may reduce direct contact between the anode material and the electrolyte solution to decrease the specific surface area of anode material particles, such that the rate performance of the anode material is improved, and the expansion effect of the silicon material is relieved. Preferably, the coating layer selects a conductive material, and can also improve the conductivity of an active layer of a core shell structure.

In some implementations, the thickness of the coating layer is 10%-20% of a total thickness of the first silicon material layer, the buffer layer, the second silicon material layer, and the coating layer, may specifically be 10%, 11%, 12%, 13%, 14%, 15%, 16%, 17%, 18%, 19%, 20%, or the like, or may definitely be other numerical values within the above range, which is not limited herein.

In some implementations, the thickness of the coating layer is 0.01 μm-1 μm, may specifically be 0.01 μm, 0.05 μm, 0.1 μm, 0.2 μm, 0.3 μm, 0.4 μm, 0.5 μm, 0.6 μm, 0.7 μm, 0.8 μm, 0.9 μm, 1 m, or the like, or may definitely be other numerical values within the above range, which is not limited herein.

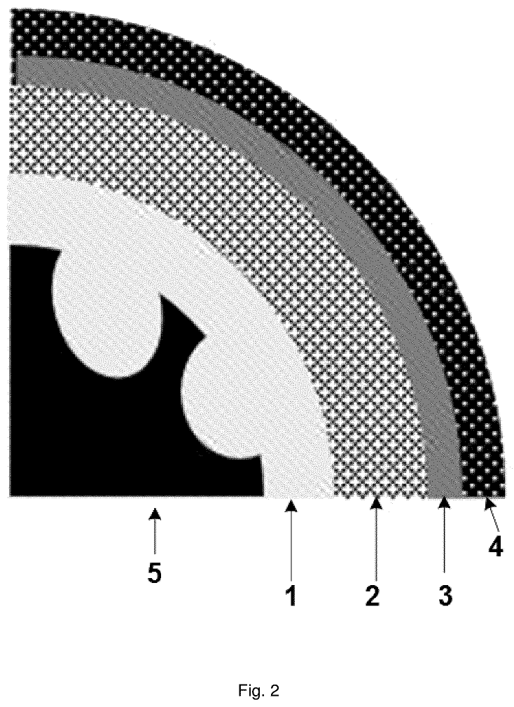

In some implementations, as shown in FIG. 2, the anode material further includes a porous substrate material. The first silicon material layer is located on a surface of the porous substrate material.

In some implementations, the porous substrate material includes porous carbon, a porous organic framework, or a mixed porous material of other elements. Further, micropores, the porous substrate material is provided with micropore (with an aperture being less than 2 nm), mesopores (with an aperture being 2 nm-50 nm), or macropores (with an aperture being greater than 50 nm). Different anode materials are prepared by the porous substrate materials with different apertures.

Preferably, the porous substrate material is a porous conductive framework material. Multilayer structures are formed on a surface and pores of the porous conductive framework material, so as to obtain the anode material. The capacity of the anode material can be regulated through a preferred framework material.

In some implementations, the porosity of the porous substrate material is 40%-60%, may specifically be 40%, 43%, 45%, 47%, 50%, 52%, 55%, 57%, 58%, 59%, 60%, or the like, or may definitely be other values within the above range, which is not limited herein.

In some implementations, the specific surface area of the porous substrate material is 50 m²/g-2500 m²/g, may specifically be 50 m²/g, 100 m²/g, 200 m²/g, 300 m²/g, 500 m²/g, 1000 m²/g, 1200 m²/g, 1500 m²/g, 1700 m²/g, 2000 m²/g, 2100 m²/g, 2300 m²/g, 2500 m²/g, or the like, or may definitely be other values within the above range, which is not limited herein.

In some implementations, the particle size of the porous substrate material is 5 μm-20 μm, may specifically be 5 μm, 7 μm, 10 μm, 13 μm, 15 μm, 16 μm, 17 μm, 18 μm, 19 μm, 20 μm, or the like, or may definitely be other values within the above range, which is not limited herein.

In some implementations, the aperture size of the porous substrate material is 5 nm-100 nm, may specifically be 5 nm, 10 nm, 15 nm, 30 nm, 45 nm, 50 nm, 60 nm, 75 nm, 80 nm, 90 nm, 95 nm, 100 nm, or the like, or may definitely be other values within the above range, which is not limited herein.

In some implementations, the pore capacity of the porous substrate material is 0.01 cm³/g-1.8 cm³/g, may specifically be 0.01 cm³/g, 0.1 cm³/g, 0.5 cm³/g, 1 cm³/g, 1.1 cm³/g, 1.3 cm³/g, 1.5 cm³/g, 1.6 cm³/g, 1.7 cm³/g, 1.8 cm³/g, or the like, or may definitely be other values within the above range, which is not limited herein. The sufficient silicon material is loaded by controlling the pore capacity within the above range.

In some implementations, the porous substrate material includes at least one of porous carbon and a porous organic framework.

In some implementations, the porous substrate material is a conductive material. The porous substrate material can regulate the capacity of active substances, and relieve volume expansion; and the porous substrate material has conductive performance, such that the electron conductivity of the material can be improved, and the rate performance of the material may be improved.

In some implementations, at least part of the first silicon material layer is filled in a pore structure of the porous substrate material.

In some implementations, partial buffer layer material of the buffer layer is also filled in the pore structure of the porous substrate material, such that the pore structure of the porous substrate material is further filled, thereby increasing the volume capacity of the material. Furthermore, the porous substrate material, the first silicon material layer, and the buffer layer form a sandwich-like structure, such that the first silicon material layer may be protected. In some implementations, a filling rate of the pore structure of the porous substrate material is 40%-80%, may specifically be 40%, 45%, 50%, 55%, 60%, 65%, 70%, 75%, 80%, or the like, and may be other values within the above range, which is not limited herein. It is understandable that, the remaining pores of the porous substrate material may reserve space for the expansion of the silicon material.

In some implementations, the anode material is provided with a pore structure.

In some implementations, the anode material is provided with the pore structure, and the pore structure includes micropores, mesopores and macropores.

In some implementations, the anode material is provided with the pore structure, and the pore structure includes the micropores, the mesopores and the macropores. A volume proportion of the micropores in the pore structure is greater than 70%, a volume proportion of the mesopores in the pore structure is greater than 20%, and a volume proportion of the macropores in the pore structure is less than 10%.

In some implementations, the anode material is provided with the pore structure, and the pore structure has a pore volume being 0.001 cm³/g-0.1 cm³/g, may specifically have the pore volume being 0.001 cm³/g, 0.01 cm³/g, 0.03 cm³/g, 0.05 cm³/g, 0.06 cm³/g, 0.07 cm³/g, 0.08 cm³/g, 0.09 cm³/g, 0.1 cm³/g, or the like, or may definitely be other numerical values within the above range, which is not limited herein.

In some implementations, the tap density of the anode material is 0.5 cm³/g-1.5 cm³/g, may specifically be 0.05 cm³/g, 0.1 cm³/g, 0.5 cm³/g, 0.6 cm³/g, 0.7 cm³/g, 0.8 cm³/g, 0.9 cm³/g, 1 cm³/g, 1.1 cm³/g, 1.2 cm³/g, 1.3 cm³/g, 1.4 cm³/g, 1.5 cm³/g, or the like, or may definitely be other values within the above range, which is not limited herein.

In some implementations, the specific surface area of the anode material is 5 m²/g-30 m²/g, may specifically be 5 m²/g, 10 m²/g, 15 m²/g, 17 m²/g, 20 m²/g, 23 m²/g, 25 m²/g, 26 m²/g, 29 m²/g, 30 m²/g, or the like, or may definitely be other values within the above range, which is not limited herein.

The anode material provided in the embodiments has the multilayer structure, and the multilayer structure includes the silicon material layers with different densities. The obtained first silicon material layer with low density achieves a relatively-uniform volume change during charging and discharging, such that the fragmentation and pulverization of the material are reduced. The second dense silicon material layer may reduce the reaction of the first silicon material layer with the electrolyte solution. In some preferred embodiments, the coating layer selects a conductive material, such that the ionic conductivity of the anode material is improved, and battery active materials are effectively prevented from being in direct contact with the electrolyte solution. Through the buffer layer and the coating layer, an electrolyte solution interface can be stabilized, and the reversible capacity of the anode material may also be increased.

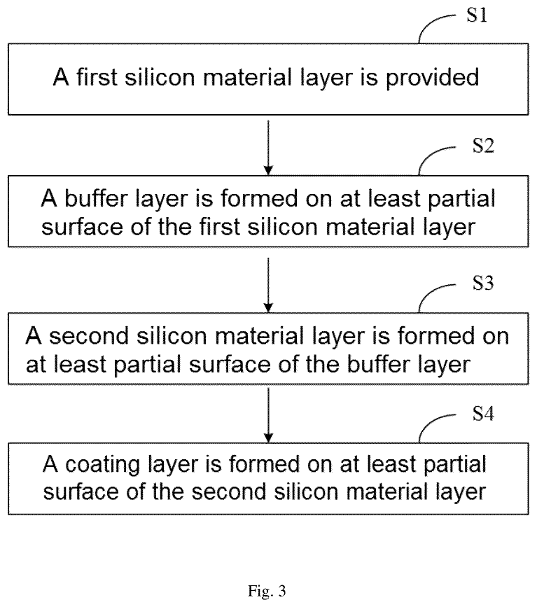

An embodiment of the present disclosure provides a method for preparing an anode material. As shown in FIG. 3, the method includes the following steps.

At S1, a first silicon material layer is provided.

At S2, a buffer layer is formed on at least partial surface of the first silicon material layer.

At S3, a second silicon material layer is formed on at least partial surface of the buffer layer.

At S4, a coating layer is formed on at least partial surface of the second silicon material layer.

The density of the first silicon material layer is less than the density of the second silicon material layer.

The preparation method of the present disclosure is specifically introduced with reference to embodiments.

At S1, a first silicon material is provided.

In some implementations, the first silicon material is spherical particles or quasi spherical particles.

In some implementations, the particle size of the first silicon material is 0.01 μm-5 μm, may specifically be 0.01 μm, 0.1 μm, 0.5 μm, 1 μm, 1.5 μm, 2 μm, 2.5 μm, 3 μm, 3.5 μm, 4 μm, 4.5 μm, 5 μm, or the like, or may definitely be other numerical values within the above range, which is not limited herein.

In some implementations, a first silicon material includes at least one of amorphous silicon and crystalline silicon. Preferably, the first silicon material is the amorphous silicon. The amorphous silicon material has an amorphous structure, which may effectively prevent the silicon material from being pulverized, such that mechanical failure of the silicon material is reduced, and the cycle life of the anode material can also be prolonged.

In some implementations, the first silicon material is provided with pores.

In some implementations, the porosity of the first silicon material is 1%-40%, may specifically be 1%, 5%, 10%, 15%, 20%, 25%, 30%, 35%, 40%, or the like, or may definitely be other values within the above range, which is not limited herein.

In some implementations, the pores of the first silicon material layer have an aperture size being 5 nm-100 nm, may specifically have the aperture size being 5 nm, 10 nm, 20 nm, 25 nm, 30 nm, 40 nm, 50 nm, 60 nm, 70 nm, 80 nm, 90 nm, 100 nm, or the like, or may definitely be other values within the above range, which is not limited herein.

In some implementations, the first silicon material has a pore volume being 0.01 cm³/g-0.5 cm³/g, may specifically have the pore volume being 0.01 cm³/g, 0.1 cm³/g, 0.2 cm³/g, 0.3 cm³/g, 0.4 cm³/g, 0.5 cm³/g, or the like, or may definitely be other values within the above range, which is not limited herein.

It is understandable that, the first silicon material is used as a substrate layer, and a multilayer structure is formed on a surface of the substrate layer.

In some implementations, the mass of hydrogen in the first silicon material layer accounts for 0.01%-10% of the mass of the first silicon material layer, may specifically account for 0.01%, 0.05%, 0.1%, 1%, 1.5%, 2%, 3%, 4.5%, 5%, 5.5%, 6%, 7%, 8%, 9%, 10%, or the like, or may definitely be other values within the above range, which is not limited herein.

In some implementations, the density of the first silicon material layer is 1.9 g/cm³-2.1 g/cm³, may specifically be 1.9 g/cm³, 1.91 g/cm³, 1.92 g/cm³, 1.93 g/cm³, 1.94 g/cm³, 1.95 g/cm³, 2.0 g/cm³, 2.1 g/cm³, or the like, or may definitely be other numerical values within the range of 1.9 g/cm³-2.1 g/cm³, which is not limited herein.

In some implementations, the thickness of the first silicon material layer is 20%-40% of a total thickness of the first silicon material layer, the buffer layer, the second silicon material layer, and the coating layer, may specifically be 20%, 25%, 30%, 35%, 36%, 37%, 38%, 39%, 40%, or the like, or may definitely be other values within the above range, which is not limited herein.

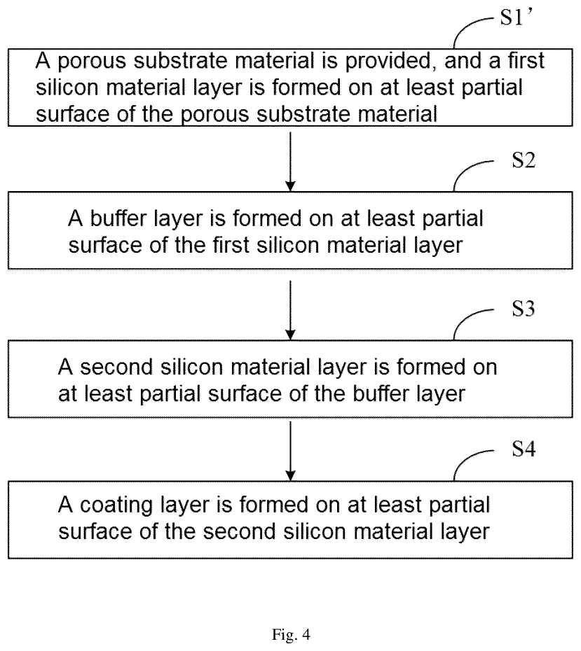

In some implementations, as shown in FIG. 4, S1′ includes:

A porous substrate material is provided, and a first silicon material layer is formed on at least partial surface of the porous substrate material.

In some implementations, the specific step of forming the first silicon material layer on at least partial surface of the porous substrate material includes: putting the porous substrate material in a vapor deposition reaction chamber, heating the reaction chamber in an inert gas atmosphere (e.g., under an argon gas), until a temperature reaches a reaction temperature for silicon deposition, introducing a gas phase silicon source in the reaction chamber, performing silicon deposition coating, and performing deposition on the porous substrate material to form the first silicon material layer.

In some implementations, a deposition temperature for forming the first silicon material layer by using a vapor deposition method is 400° C.-800° C., may specifically be 400° C., 450° C., 500° C., 550° C., 600° C., 650° C., 700° C., 750° C., 800° C., or the like, and may be other values within the above range, which is not limited herein.

Generally, when the deposition temperature is below 600° C., amorphous silicon is obtained; and when the deposition temperature is above 600° C., crystalline silicon is obtained. Preferably, the deposition temperature is 400° C.-500° C., i.e., within deposition time, the temperature of the reaction chamber is maintained at 400° C.-500° C. all the time. When the reaction chamber is heated, heating may be started at a rate of 10° C./min, until the temperature reaches 400° C.-500° C. When the temperature reaches 400° C.-500° C., the inert gas may be continuously introduced instead of rushing to introduce the gas phase silicon source, and the temperature is maintained for a period of time, for example, maintained for 1 h, then the gas phase silicon source is introduced. In this way, the temperature of the reaction chamber can be stabilized to stabilize the temperature within the reaction temperature for silicon deposition. Before the reaction chamber is heated, the entire reaction chamber is purged for multiple times with the inert gas such as nitrogen, so as to remove impurities.

In some implementations, deposition time for forming the first silicon material layer by using the vapor deposition method is 2 h-6 h, may specifically be 2 h, 3 h, 4 h, 5 h, 6 h, and is not limited herein.

In some implementations, the step of forming the first silicon material layer by using the vapor deposition method further includes introducing the gas phase silicon source.

In some implementations, the step of forming the first silicon material layer by using the vapor deposition method further includes introducing the gas phase silicon source. A total flow rate of the gas phase silicon source is 100 sccm-500 sccm, may specifically be 100 sccm, 150 sccm, 200 sccm, 250 sccm, 300 sccm, 350 sccm, 400 sccm, 450 sccm, 500 sccm, or may definitely be other values within the above range, which is not limited herein. Preferably, the total flow rate of the gas phase silicon source is 200 sccm.

In some implementations, the step of forming the first silicon material layer by using the vapor deposition method further includes introducing the gas phase silicon source and an inert carrier gas.

In some implementations, the step of forming the first silicon material layer by using the vapor deposition method further includes introducing the gas phase silicon source and the inert carrier gas. The inert carrier gas includes at least one of nitrogen, argon, and helium.

In some implementations, the step of forming the first silicon material layer by using the vapor deposition method further includes introducing the gas phase silicon source and the inert carrier gas. A total flow rate of the gas phase silicon source and the inert carrier gas is 100 sccm-500 sccm, may specifically be 100 sccm, 150 sccm, 200 sccm, 250 sccm, 300 sccm, 350 sccm, 400 sccm, 450 sccm, 500 sccm, or may definitely be other values within the above range, which is not limited herein. Preferably, the total flow rate is 200 sccm.

In some implementations, the step of forming the first silicon material layer by using the vapor deposition method further includes introducing the gas phase silicon source and the inert carrier gas. A volume proportion of the gas phase silicon source in a gas is 5%-100%, may specifically be 5%, 10%, 20%, 30%, 40%, 50%, 60%, 70%, 80%, 90%, 100%, or the like, and may also be other values within the above range. Preferably, the volume proportion is 8%-15%.

In some implementations, the step of forming the first silicon material layer by using the vapor deposition method further includes introducing a dopant gas.

In some implementations, the step of forming the first silicon material layer by using the vapor deposition method further includes introducing the dopant gas. The dopant gas may be NH₃ or PH₃. Performance modification may be performed on the first silicon material layer by introducing the dopant gas.

In some implementations, the step of forming the first silicon material layer by using the vapor deposition method (CVD) specifically includes preferably using plasma to enhance the vapor deposition method (PECVD) for vapor deposition. Under the assistance of the plasma, the gas phase silicon source is more easily to decompose at high temperatures. By means of PECVD, efficient low-temperature deposition of the gas phase silicon source on the porous substrate material can be performed, such that the silicon materials are uniformly deposited on the porous substrate material; and the reaction temperature is lower, and the lower temperature facilitates the formation of the amorphous silicon, thereby protecting the stability of the amorphous silicon. It is understandable that, when a target product of a silicon layer is the amorphous silicon, the PECVD is preferred.

During deposition, an air pressure of the reaction chamber is maintained at 0.1 Torr to an ordinary pressure, preferably, 0.1 Torr-100 Torr; and a rotation speed of a reaction furnace is 3 rpm-10 rpm to realize homogeneous in-situ coating deposition. When the plasma vapor deposition method is used, in order to enhance the decomposition of silane, the plasma is ignited in the chamber, radio frequency power is maintained between 10 W and 100 W, and pulsed plasma may be used. The amorphous silicon prepared under the deposition condition is provided with a microporous structure, low in density, and suitable for the formation of a thick deposition layer, such that the capacity of the silicon in the anode material is increased, and the high-capacity anode material is obtained. In addition, the inert gas is always protected during vapor deposition, i.e., silicon deposition is performed under anaerobic conditions. Silicon oxidation may be prevented during an anaerobic (vapor deposition method) CVD preparation process, and the formation of surface oxide layers is reduced.

At S2, a buffer layer is formed on at least partial surface of the first silicon material.

In some implementations, the S2 of using the vapor deposition method to form the buffer layer specifically includes: adding, to the reaction chamber, the first silicon material or the porous substrate material of which surface is deposited with the first silicon material layer, adjusting the temperature of the reaction chamber to a reaction temperature for carbon deposition, introducing a gas phase carbon source in the reaction chamber, performing carbon deposition coating, and depositing a carbon deposition layer on the first silicon material layer to form the buffer layer. The buffer layer is formed on the surface of the first silicon material layer and inside pores of a porous skeletal material.

In some implementations, when deposition is continuously performed on the first silicon material layer deposited on the surface of the porous substrate material, so as to form the buffer layer, a specific step includes: after depositing the first silicon material layer, stopping heating the reaction chamber, stopping introducing the silicon-containing gas, and introducing inert gases such as Argon (Ar) instead, until the reaction chamber is cooled to room temperature. Then, the reaction chamber is re-heated when the argon is continuously introduced, so as to rise the temperature of the reaction chamber to the reaction temperature for carbon deposition. That is, after silicon-containing deposition is completed, the temperature is cooled to the room temperature under the protection of the inert gases, and then the deposition of the buffer layer is performed through heating, such that the deposition of the previous layer can be more thorough, precursor residues are prevented from affecting the deposition of other layers subsequently.

In some implementations, when deposition is performed on the first silicon material to form the buffer layer, a specific step includes: heating the reaction chamber while introducing the argon, to rise the temperature of the reaction chamber to the reaction temperature for carbon deposition, so as to perform the deposition of the buffer layer.

In some implementations, a deposition temperature for forming the buffer layer by using the vapor deposition method is 450° C.-800° C., may specifically be 450° C., 500° C., 550° C., 600° C., 650° C., 700° C., 750° C., 800° C., or the like, and may also be other values within the above range, which is not limited herein. Preferably, the deposition temperature is 500° C.-650° C., i.e., within the deposition time, the temperature of the reaction chamber is maintained at 500° C.-650° C. all the time. Similarly, when the reaction chamber is heated, temperature rising may start at a rate of 10° C./min, until the temperature reaches 500° C.-650° C., and the gas phase carbon source is started to introduce after the temperature is held for 1 h.

In some implementations, deposition time for forming the buffer layer by using the vapor deposition method is 0.5 h-3 h, may specifically be 0.5 h, 1 h, 1.5 h, 2 h, 2.5 h, 3 h, or the like, and is not limited herein.

In some implementations, the step of forming the buffer layer by using the vapor deposition method further includes introducing a gas phase carbon source.

In some implementations, the step of forming the buffer layer by using the vapor deposition method further includes introducing the gas phase carbon source. A total flow rate of the gas phase carbon source is 100 sccm-500 sccm, may specifically be 100 sccm, 150 sccm, 200 sccm, 250 sccm, 300 sccm, 350 sccm, 400 sccm, 450 sccm, or 500 sccm, or may definitely be other values within the above range. Preferably, the total flow rate of the gas phase carbon source is 200 sccm.

In some implementations, the step of forming the buffer layer by using the vapor deposition method further includes introducing the gas phase carbon source and an inert carrier gas.

In some implementations, the step of forming the buffer layer by using the vapor deposition method further includes introducing the gas phase carbon source and the inert carrier gas. The inert carrier gas includes at least one of nitrogen, argon, and helium.

In some implementations, the step of forming the buffer layer by using the vapor deposition method further includes introducing the gas phase carbon source and the inert carrier gas. A total flow rate of the gas phase carbon source and the inert carrier gas is 100 sccm-500 sccm, may specifically be 100 sccm, 150 sccm, 200 sccm, 250 sccm, 300 sccm, 350 sccm, 400 sccm, 450 sccm, 500 sccm, or may definitely be other values within the above range, which is not limited herein. Preferably, the total flow rate of the gas phase carbon source and the inert carrier gas is 200 sccm.

In some implementations, the step of forming the buffer layer by using the vapor deposition method further includes introducing the gas phase carbon source and the inert carrier gas. A volume ratio of the gas phase carbon source to the inert carrier gas is 1:(1-10), and may specifically be 1:1, 1:2, 1:3, 1:4, 1:5, 1:6, 1:7, 1:8, 1:9, 1:10, etc., which is not limited herein.

In some implementations, the step of forming the buffer layer by using the vapor deposition method further includes introducing the gas phase carbon source and the inert carrier gas. The gas phase carbon source includes any one or a combination of at least two of methane, ethane, propane, ethylene, acetylene, gaseous benzene, gaseous toluene, gaseous xylene, gaseous ethanol, and gaseous acetone.

In some implementations, the step of forming the buffer layer by using the vapor deposition method further includes filling at least partial carbon material formed through the cracking of the gas phase carbon source in pores of the first silicon material layer.

In some implementations, the step of forming the buffer layer by using the vapor deposition method specifically includes using plasma to enhance the vapor deposition method (PECVD) for vapor deposition. When the first silicon material is the amorphous silicon, the plasma is used to enhance the vapor deposition method (PECVD) for carbon deposition, such that carbon coating may be realized at a low temperature (5600° C.), and the amorphous silicon is protected from damage. During the deposition of the gas phase carbon source, the air pressure of the reaction chamber is maintained at 10 Torr to the ordinary pressure, and the rotation speed of the reaction furnace is 3 rpm-10 rpm to realize homogeneous in-situ coating deposition. When the plasma vapor deposition method is used, the radio frequency power is maintained between 10 W and 100 W.

In some implementations, S2 may specifically include:

Mixing the first silicon material and the buffer layer raw material in a solvent, then performing drying and curing to form the buffer layer on the at least partial surface of the first silicon material layer.

In some implementations, the buffer layer raw material includes at least one of a carbon material, a metallic oxide, a conductive polymer material, and a nitride.

In some implementations, the buffer layer raw material includes the carbon material, and the carbon material includes at least one of soft carbon, hard carbon, crystalline carbon, and amorphous carbon.

In some implementations, the buffer layer raw material includes the metallic oxide, and the metallic oxide includes at least one of titanium oxide, aluminum oxide, lithium oxide, cobalt oxide, and vanadium oxide.

In some implementations, the buffer layer raw material includes a conductive polymer, and the conductive polymer includes at least one of polyaniline, polyacetylene, polypyrrole, polythiophene, poly(3-hexylthiophene), poly(para-styrene), polypyridine, and poly(phenylene ethylene).

In some implementations, the buffer layer raw material includes the nitride, and the nitride includes at least one of titanium nitride, vanadium nitride, cobalt nitride, nickel nitride, and carbon nitride.

In some implementations, a temperature of drying and curing is 80° C.-150° C., and may specifically be 80° C., 90° C., 100° C., 110° C., 120° C., 130° C., 140° C., 150° C., etc., which is not limited herein. Temperature-holding time for drying and curing is 1 h-12 h, may specifically be 1 h, 2 h, 3 h, 4 h, 5 h, 6 h, 7 h, 8 h, 9 h, 10 h, 11 h, 12 h, etc., or may also be other values within the above range, which is not limited herein.

In some implementations, after the substance after the first silicon material layer is formed and the buffer layer raw material are mixed in the solvent, and then drying and curing are performed, the method further includes performing heat treatment on dried and cured products. A temperature of the heat treatment is 400° C.-900° C., may specifically be 400° C., 500° C., 600° C., 700° C., 800° C., 900° C., or may also be other values within the above range. Temperature-holding time for the heat treatment is 1 h-12 h, may specifically be 1 h, 2 h, 3 h, 4 h, 5 h, 6 h, 7 h, 8 h, 9 h, 10 h, 11 h, 12 h, etc., or may also be other values within the above range, which is not limited herein.

At S3, a second silicon material layer is formed on at least partial surface of the buffer layer.

In some implementations, the S3 specifically includes: after forming the buffer layer, adjusting the temperature of the reaction chamber to a reaction temperature for silicon deposition, introducing the gas phase silicon source in the reaction chamber, performing silicon deposition coating under a condition of rotating the reaction furnace, and depositing a silicon deposition layer on the buffer layer, so as to form the second silicon material layer.

In some implementations, the specific operation of adjusting the temperature of the reaction chamber to the reaction temperature for silicon deposition includes: after the carbon-containing buffer layer is deposited, stopping heating the reaction chamber, stopping introducing the gas phase carbon source, and introducing the inert gases such as Argon (Ar) instead, until the reaction chamber is cooled to the room temperature. Then, the reaction chamber is re-heated when the argon is continuously introduced, so as to rise the temperature of the reaction chamber to the reaction temperature for silicon deposition. Temperature rising may start at a rate of 10° C./min, until the temperature reaches 500° C.-550° C. Similarly, by means of performing cooling first and then performing temperature rising, the deposition of the previous layer can be more thorough, precursor residues are prevented from affecting the deposition of other layers subsequently.

In some implementations, a deposition temperature for forming the second silicon material layer by using a vapor deposition method is 400° C.-800° C., may specifically be 400° C., 450° C., 500° C., 550° C., 600° C., 650° C., 700° C., 750° C., 800° C., or the like, and may be other values within the above range, which is not limited herein.

Preferably, the deposition temperature is 500° C.-550° C., which is higher than the deposition temperature for forming the first silicon material layer. During the deposition of the gas phase silicon source, a deposition air pressure is 0.1 Torr to an ordinary pressure, and the rotation speed of the reaction furnace is 3 rpm-10 rpm to realize homogeneous in-situ coating deposition.

In some implementations, the step of forming the second silicon material layer by using the vapor deposition method specifically includes using the plasma to enhance the vapor deposition method (PECVD) for vapor deposition. When the plasma vapor deposition method is used, the radio frequency power is maintained between 10 W and 100 W.

In some implementations, deposition time for forming the second silicon material layer by using the vapor deposition method is 2 h-6 h, may specifically be 2 h, 3 h, 4 h, 5 h, 6 h, and is not limited herein.

In some implementations, the step of forming the first silicon material layer by using the vapor deposition method further includes introducing the gas phase silicon source.

In some implementations, the step of forming the second silicon material layer by using the vapor deposition method further includes introducing the gas phase silicon source. A total flow rate of the gas phase silicon source is 100 sccm-500 sccm, may specifically be 100 sccm, 150 sccm, 200 sccm, 250 sccm, 300 sccm, 350 sccm, 400 sccm, 450 sccm, 500 sccm, or may definitely be other values within the above range, which is not limited herein. Preferably, the total flow rate of the gas phase silicon source is 200 sccm.

In some implementations, the step of forming the second silicon material layer by using the vapor deposition method further includes introducing the gas phase silicon source and an inert carrier gas.

In some implementations, the step of forming the second silicon material layer by using the vapor deposition method further includes introducing the gas phase silicon source and the inert carrier gas. The inert carrier gas includes at least one of nitrogen, argon, and helium.

In some implementations, the step of forming the second silicon material layer by using the vapor deposition method further includes introducing the gas phase silicon source and the inert carrier gas. A total flow rate of the gas phase silicon source and the inert carrier gas is 100 sccm-500 sccm, may specifically be 100 sccm, 150 sccm, 200 sccm, 250 sccm, 300 sccm, 350 sccm, 400 sccm, 450 sccm, 500 sccm, or may definitely be other values within the above range, which is not limited herein. Preferably, the total flow rate is 200 sccm.

In some implementations, the step of forming the second silicon material layer by using the vapor deposition method further includes introducing the gas phase silicon source and the inert carrier gas. A volume proportion of the gas phase silicon source in a gas is 5%-100%, may specifically be 5%, 10%, 20%, 30%, 40%, 50%, 60%, 70%, 80%, 90%, 100%, or the like, and may also be other values within the above range. Preferably, the volume proportion is 8%-15%.

It is to be noted that, deposition parameters of the first silicon material layer and the second silicon material layer cannot be identical to ensure that the density of two silicon material layers is different. Main factors for controlling the density of the silicon material layers are temperatures, air pressures, with or without plasma enhancement, etc. When other conditions are the same, the silicon material layer with small density is obtained more easily by using the plasma to enhance the vapor deposition method (PECVD) for vapor deposition. The deposition temperature of the first silicon material layer is preferred 400° C.-500° C., and the deposition temperature of the second silicon material layer is preferred 500° C.-550° C., i.e., the deposition temperature for forming the first silicon material layer is less than the deposition temperature for forming the second silicon material layer. In addition, if the second silicon material layer does not use the vapor deposition method (PECVD), a deposition pressure range may be expanded, such that the density of the second silicon material layer obtained through deposition is greater than the density of the first silicon material layer. The reaction time, ventilation volume, and ventilation ratio of the first silicon material layer and the second silicon material layer during deposition are changed within a given deposition condition range, such that the silicon deposition layers with different densities may be realized.

At S4, a coating layer is formed on at least partial surface of the second silicon material layer.

In some implementations, the specific step of forming the coating layer by using the vapor deposition method includes: adjusting the temperature of the reaction chamber to the reaction temperature for carbon deposition, introducing the gas phase carbon source in the reaction chamber, performing carbon deposition coating under the condition of rotating the reaction furnace, and depositing a carbon deposition layer on the second silicon material layer, so as to form a carbon deposition layer.

In some implementations, the specific operation of adjusting the temperature of the reaction chamber to the reaction temperature for carbon deposition includes: after the second silicon material layer is deposited, stopping heating the reaction chamber, stopping introducing the gas phase silicon source, and introducing the inert gases such as Argon (Ar) instead, until the reaction chamber is cooled to the room temperature. Then, the reaction chamber is re-heated when the argon is continuously introduced, so as to rise the temperature of the reaction chamber to the reaction temperature for carbon deposition. Temperature rising may start at a rate of 10° C./min, until the temperature reaches 500° C.-650° C. Similarly, by means of performing cooling first and then performing temperature rising, the deposition of the previous layer can be more thorough, precursor residues are prevented from affecting the deposition of other layers subsequently.

In some implementations, a deposition temperature for forming the coating layer by using the vapor deposition method is 400° C.-800° C., may specifically be 450° C., 500° C., 550° C., 600° C., 650° C., 700° C., 750° C., 800° C., or the like, and may also be other values within the above range, which is not limited herein. Preferably, the deposition temperature is 500° C.-650° C.

In some implementations, deposition time for forming the coating layer by using the vapor deposition method is 0.5 h-3 h, may specifically be 0.5 h, 1 h, 1.5 h, 2 h, 2.5 h, 3 h, or the like, and is not limited herein.

In some implementations, the step of forming the coating layer by using the vapor deposition method further includes introducing a gas phase carbon source.

In some implementations, the step of forming the coating layer by using the vapor deposition method further includes introducing the gas phase carbon source. A total flow rate of the gas phase carbon source is 100 sccm-500 sccm, may specifically be 100 sccm, 150 sccm, 200 sccm, 250 sccm, 300 sccm, 350 sccm, 400 sccm, 450 sccm, 500 sccm, or may definitely be other values within the above range, which is not limited herein. Preferably, the total flow rate of the gas phase carbon source is 200 sccm.

In some implementations, the step of forming the coating layer by using the vapor deposition method further includes introducing the gas phase carbon source and an inert carrier gas.

In some implementations, the step of forming the buffer layer by using the vapor deposition method further includes introducing the gas phase carbon source and the inert carrier gas. The inert carrier gas includes at least one of nitrogen, argon, and helium.

In some implementations, the step of forming the coating layer by using the vapor deposition method further includes introducing the gas phase carbon source and the inert carrier gas. A total flow rate of the gas phase carbon source and the inert carrier gas is 100 sccm-500 sccm, may specifically be 100 sccm, 150 sccm, 200 sccm, 250 sccm, 300 sccm, 350 sccm, 400 sccm, 450 sccm, 500 sccm, or may definitely be other values within the above range, which is not limited herein. Preferably, the total flow rate is 200 sccm.

In some implementations, the step of forming the coating layer by using the vapor deposition method further includes introducing the gas phase carbon source and the inert carrier gas. A volume ratio of the gas phase carbon source to the inert carrier gas is 1:(1-10), and may specifically be 1:1, 1:2, 1:3, 1:4, 1:5, 1:6, 1:7, 1:8, 1:9, 1:10, etc., which is not limited herein.

In some implementations, the step of forming the coating layer by using the vapor deposition method further includes introducing the gas phase carbon source and the inert carrier gas. The gas phase carbon source includes any one or a combination of at least two of methane, ethane, propane, ethylene, acetylene, gaseous benzene, gaseous toluene, gaseous xylene, gaseous ethanol, and gaseous acetone.

In some implementations, the step of forming the coating layer by using the vapor deposition method further includes filling at least partial carbon material formed through the cracking of the gas phase carbon source in pores of the second silicon material layer.

In some implementations, the step of forming the buffer layer and the coating layer by using the vapor deposition method specifically includes using plasma to enhance the vapor deposition method for vapor deposition. When the silicon-containing material layer is the amorphous silicon, the plasma is used to enhance the vapor deposition method (PECVD) for carbon deposition, such that carbon coating may be realized at a low temperature (≤600° C.), and the amorphous silicon is protected from damage. During deposition, the pressure of the reaction chamber is maintained at 10 Torr to the ordinary pressure, and the rotation speed of the reaction furnace is 3-10 rpm to realize homogeneous in-situ coating deposition. When the plasma vapor deposition method is used, the radio frequency power is maintained between 10 W and 100 W.

The deposition conditions of amorphous carbon in the two layers of the buffer layer and the coating layer are basically the same, and different thicknesses are adjusted through the deposition time. Ideally, the thickness of the coating layer is much less than the thickness of the buffer layer.

In some implementations, in S4, the substance after the second silicon material layer is formed and the coating layer raw material are mixed in the solvent, and then drying and curing are performed to form the coating layer on the at least partial surface of the second silicon material layer.

In some implementations, the coating layer raw material includes at least one of a carbon material, a metallic oxide, a conductive polymer material, and a nitride.

In some implementations, the coating layer raw material includes the carbon material, and the carbon material includes at least one of soft carbon, hard carbon, crystalline carbon, and amorphous carbon.

In some implementations, the coating layer raw material includes the metallic oxide, and the metallic oxide includes at least one of titanium oxide, aluminum oxide, lithium oxide, cobalt oxide, and vanadium oxide.

In some implementations, the coating layer raw material includes a conductive polymer, and the conductive polymer includes at least one of polyaniline, polyacetylene, polypyrrole, polythiophene, poly(3-hexylthiophene), poly(para-styrene), polypyridine, and poly(phenylene ethylene).

In some implementations, the coating layer raw material includes the nitride, and the nitride includes at least one of titanium nitride, vanadium nitride, cobalt nitride, nickel nitride, and carbon nitride.

In some implementations, a temperature of drying and curing is 80° C.-150° C., and may specifically be 80° C., 90° C., 100° C., 110° C., 120° C., 130° C., 140° C., 150° C., etc., which is not limited herein. Temperature-holding time for drying and curing is 1 h-12 h, may specifically be 1 h, 2 h, 3 h, 4 h, 5 h, 6 h, 7 h, 8 h, 9 h, 10 h, 11 h, 12 h, etc., or may also be other values within the above range, which is not limited herein.

In some implementations, after the substance after the second silicon material layer is formed and the coating layer raw material are mixed in the solvent, and then drying and curing are performed, the method further includes performing heat treatment on dried and cured products. A temperature of the heat treatment is 400° C.-900° C., may specifically be 400° C., 500° C., 600° C., 700° C., 800° C., 900° C., or may also be other values within the above range. Temperature-holding time for the heat treatment is 1 h-12 h, may specifically be 1 h, 2 h, 3 h, 4 h, 5 h, 6 h, 7 h, 8 h, 9 h, 10 h, 11 h, 12 h, etc., or may also be other values within the above range, which is not limited herein.

The present disclosure provides a battery, including the anode material or an anode material prepared by the method for preparing an anode material.

The present disclosure is described and explained below through several groups of specific experimental embodiments and comparative experimental example embodiments, which should not be used to limit the scope of the present disclosure.

### Embodiment 1

(1) A No. 1 porous carbon material was selected as a porous substrate material.
(2) The porous carbon material in step (1) was placed in a PECVD reaction chamber, nitrogen was used to repeatedly purge (3-5 times) the reaction chamber; then the nitrogen was turned off and an argon gas was introduced, with a flow rate being 400 sccm; then a temperature was risen to 450° C., a temperature-rising rate was 10° C./min, and after the temperature was held for 1 h, the argon was turned off and a high-purity silane gas (99.9999%) was introduced, with a flow rate being 100 sccm; a rotary speed of a reaction furnace was controlled at 5 rpm; plasma Radio Frequency (RF) power was 10 W; the pressure of the reaction chamber was 100 Torr; a deposition reaction was performed for 3 h at the temperature; and then the silane gas was turned off, the argon was introduced, and the temperature was cooled to room temperature, so as to obtain a first silicon-deposited carbon framework material layer (C/Si material). In the obtained C/Si material, the thickness of a first silicon material layer was 493 nm, the density of the first silicon material layer was 1.91 g/cm³, and hydrogen content of the first silicon material layer was 9.5%.
(3) After the reaction chamber in step (2) was cooled to room temperature, the argon was maintained to be introduced, then the temperature was risen to 600° C. with a temperature-rising rate being 10° C./min, and the temperature was held for 1 h. 1 h later, the argon was turned off, and an ethylene gas was introduced with a flow rate being 100 sccm; the rotary speed of a reaction furnace was controlled at 5 rpm; RF power was 10 W; the pressure of the reaction chamber was 100 Torr; the deposition reaction was performed for 2 h at the temperature; and then the ethylene gas was turned off, the argon was introduced, and the temperature was cooled to room temperature, so as to obtain a double-layer deposited anode material (C/Si—C material). In the C/Si—C material, a carbon deposition (i.e., a buffer layer) was an amorphous carbon deposition layer, and the thickness of the buffer layer was 412 nm.
(4) After the reaction chamber in step (3) was cooled to room temperature, the argon gas was continuously introduced with a flow rate being 400 sccm, then the temperature was risen to 500° C. with a temperature-rising rate being 10° C./min, and the temperature was held for 1 h. 1 h later, the argon was turned off, and the silane gas was introduced with a flow rate being 100 sccm; the rotary speed of a reaction furnace was controlled at 5 rpm; RF power was 20 W; the pressure of the reaction chamber was 100 Torr; the deposition reaction was performed for 1 h at the temperature; and then the silane gas was turned off, the argon was introduced, and the temperature was cooled to room temperature, so as to obtain a three-layer deposited anode material (C/Si—C—Si material). In the obtained C/Si—C—Si material, a second silicon material layer was an amorphous silicon deposition layer, the thickness of the second silicon material layer was 166 nm, the density of the second silicon material layer was 2.21 g/cm³, and hydrogen content of the second silicon material layer was 3.5%.
(5) After the reaction chamber in step (4) was cooled to room temperature, the argon gas was continuously introduced with a flow rate being 400 sccm, then the temperature was risen to 600° C. with a temperature-rising rate being 10° C./min, and the temperature was held for 1 h. 1 h later, the argon was turned off, and the ethylene gas was introduced with the flow rate being 100 sccm; the rotary speed of a reaction furnace was controlled at 5 rpm; the RF power was 10 W; the pressure of the reaction chamber was 100 Torr; the deposition reaction was performed for 0.5 h at the temperature; and then the ethylene gas was turned off, the argon was introduced, and the temperature was cooled to room temperature, so as to obtain a four-layer deposited anode material. In the anode material, a carbon deposition (i.e., a coating layer) was an amorphous conductive carbon deposition layer, and the thickness of the coating layer was 101 nm.

### Embodiments 2-10

Process steps of Embodiments 2-10 were basically the same as Embodiment 1, and some of reaction conditions were different, for example, parameters such as the selection of a porous substrate material, the vapor phase deposition temperature, the silicon source used, the vapor phase deposition time, the gas flow rate of the silicon source, the air pressure of the chamber, and the RF power in S1; the vapor phase deposition temperature, the gas phase carbon source used, the deposition time, the gas flow rate of the gas phase carbon source, the air pressure of the chamber, and the RF power in S2; the vapor phase deposition temperature, the silicon source used, the vapor phase deposition time, the gas flow rate of the silicon source, the air pressure of the chamber, and the RF power in S3; the vapor phase deposition time, the gas phase carbon source used, the deposition time, the gas flow rate, the air pressure of the chamber, and the RF power in S4, etc. Parameters of the porous carbon substrate material were shown in detail in Table 1, and parameters of the preparation process of the anode material were shown in detail in Table 2.

TABLE 1
Parameters of porous carbon substrate material

| Serial number of porous carbon substrate material | 1 | 2 | 3 | 4 |
|---|---|---|---|---|
| Porous carbon substrate material D50 (μm) | 5.2 | 10.7 | 2.6 | 18.9 |
| Specific surface area of porous carbon substrate material (m²/g) | 578 | 1162 | 54 | 2043 |
| Pore capacity of porous carbon substrate material (cm³/g) | 0.83 | 0.94 | 0.27 | 1.21 |

TABLE 2
Parameters of preparation process of silicon composite material

| | Embod- | | Embod- | | Embod- | | Embod- | | Embod- | | Embod- | | Embod- | |
|---|---|---|---|---|---|---|---|---|---|---|---|---|---|---|
| | iment | | iment | | iment | | iment | | iment | | iment | | iment | |
| | 1 | | 2 | | 3 | | 4 | | 5 | | 6 | | 7 | |
| Serial | 1 | | 2 | | 3 | | 4 | | 2 | | 4 | | 1 | |
| number | | | | | | | | | | | | | | |
| of | | | | | | | | | | | | | | |
| porous | | | | | | | | | | | | | | |
| carbon | | | | | | | | | | | | | | |
| sub- | | | | | | | | | | | | | | |
| strate | | | | | | | | | | | | | | |
| ma- | | | | | | | | | | | | | | |
| terial | | | | | | | | | | | | | | |
| S1 | 450° | C. | 400° | C. | 450° | C. | 475° | C. | 500° | C. | 400° | C. | 425° | C. |
| temper- | | | | | | | | | | | | | | |
| ature | | | | | | | | | | | | | | |
| S1 | Silane | | Silane | | Disilane | | Silane | | Silane | | Silane | | Silane | |
| silicon | 100% | | (5% | | (100%) | | and | | 100% | | 100% | | 100% | |
| source | | | silane | | | | disilane | | | | | | | |
| | | | mixed | | | | (mixing | | | | | | | |
| | | | with | | | | in 2:1) | | | | | | | |
| | | | Ar) | | | | in | | | | | | | |
| | | | | | | | 90% | | | | | | | |
| | | | | | | | AR | | | | | | | |
| | | | | | | | atmo- | | | | | | | |
| | | | | | | | sphere | | | | | | | |
| S1 | 3 | h | 4 | h | 2 | h | 6 | h | 3 | h | 2 | h | 1.5 | h |
| depo- | | | | | | | | | | | | | | |
| sition | | | | | | | | | | | | | | |
| time | | | | | | | | | | | | | | |
| S1 gas | 100 | sccm | 300 | sccm | 100 | sccm | 300 | sccm | 200 | sccm | 300 | sccm | 400 | sccm |
| flow | | | | | | | | | | | | | | |
| rate | | | | | | | | | | | | | | |
| S1 | 100 | Torr | 50 | Torr | 100 | Torr | 50 | Torr | 1 | Torr | 300 | Torr | 100 | Torr |
| cham- | | | | | | | | | | | | | | |
| ber | | | | | | | | | | | | | | |
| air | | | | | | | | | | | | | | |
| pres- | | | | | | | | | | | | | | |
| sure | | | | | | | | | | | | | | |
| S1 RF | 10 | W | 20 | W | 20 | W | 50 | W | 40 | W | 10 | W | 20 | W |
| power | | | | | | | | | | | | | | |
| S2 | 600° | C. | 550° | C. | 800° | C. | 550° | C. | 550° | C. | 500° | C. | 550° | C. |
| temper- | | | | | | | | | | | | | | |
| ature | | | | | | | | | | | | | | |
| S2 | Ethylene | | Methane | | Acetylene | | Ethylene | | Methane | | Ethylene | | Methane | |
| carbon | | | | | | | | | | | | | | |
| source | | | | | | | | | | | | | | |
| S2 | 2 | h | 2 | h | 0.5 | h | 0.5 | h | 0.5 | h | 1 | h | 0.5 | h |
| depo- | | | | | | | | | | | | | | |
| sition | | | | | | | | | | | | | | |
| time | | | | | | | | | | | | | | |
| S2 gas | 100 | sccm | 200 | sccm | 200 | sccm | 300 | sccm | 200 | sccm | 100 | sccm | 200 | sccm |
| flow | | | | | | | | | | | | | | |
| rate | | | | | | | | | | | | | | |
| S2 | 100 | Torr | 50 | Torr | 400 | Torr | 200 | Torr | 500 | Torr | 300 | Torr | 100 | Torr |
| cham- | | | | | | | | | | | | | | |
| ber | | | | | | | | | | | | | | |
| air | | | | | | | | | | | | | | |
| pres- | | | | | | | | | | | | | | |
| sure | | | | | | | | | | | | | | |
| S2 RF | 10 | W | 20 | W | 10 | W | 30 | W | 80 | W | 20 | W | 30 | W |
| power | | | | | | | | | | | | | | |
| S3 | 500° | C. | 520° | C. | 500° | C. | 525° | C. | 500° | C. | 500° | C. | 500° | C. |
| temper- | | | | | | | | | | | | | | |
| ature | | | | | | | | | | | | | | |
| S3 | Silane | | Silane | | Silane | | Disilane | | Silane | | Silane | | Silane | |
| silicon | 100% | | 100% | | (5% | | (100%) | | and | | 100% | | 100% | |
| source | | | | | silane | | | | disilane | | | | | |
| | | | | | mixed | | | | (mixing | | | | | |
| | | | | | with | | | | in | | | | | |
| | | | | | Ar) | | | | 2:1) in | | | | | |
| | | | | | | | | | 90% | | | | | |
| | | | | | | | | | AR | | | | | |
| | | | | | | | | | atmo- | | | | | |
| | | | | | | | | | sphere | | | | | |
| S3 | 1 | h | 1 | h | 2 | h | 2 | h | 0.5 | h | 1 | h | 0.5 | h |
| depo- | | | | | | | | | | | | | | |
| sition | | | | | | | | | | | | | | |
| time | | | | | | | | | | | | | | |
| S3 gas | 100 | sccm | 150 | sccm | 250 | sccm | 200 | sccm | 200 | sccm | 300 | sccm | 400 | sccm |
| flow | | | | | | | | | | | | | | |
| rate | | | | | | | | | | | | | | |
| S3 | 100 | Torr | 200 | Torr | 50 | Torr | 1 | Torr | 200 | Torr | 400 | Torr | 300 | Torr |
| cham- | | | | | | | | | | | | | | |
| ber | | | | | | | | | | | | | | |
| air | | | | | | | | | | | | | | |
| pres- | | | | | | | | | | | | | | |
| sure | | | | | | | | | | | | | | |
| S3 RF | 20 | W | 10 | W | 20 | W | — | | 100 | W | 50 | W | 80 | W |
| power | | | | | | | | | | | | | | |
| S4 | 600° | C. | 550° | C. | 800° | C. | 600° | C. | 550° | C. | 575° | C. | 600° | C. |
| temper- | | | | | | | | | | | | | | |
| ature | | | | | | | | | | | | | | |
| S4 | Ethylene | | Methane | | Acetylene | | Ethylene | | Methane | | Ethylene | | Methane | |
| carbon | | | | | | | | | | | | | | |
| source | | | | | | | | | | | | | | |
| S4 | 0.5 | h | 1 | h | 1 | h | 0.5 | h | 0.5 | h | 1 | h | 1.5 | h |
| depo- | | | | | | | | | | | | | | |
| sition | | | | | | | | | | | | | | |
| time | | | | | | | | | | | | | | |
| S4 gas | 100 | sccm | 200 | sccm | 400 | sccm | 200 | sccm | 200 | sccm | 200 | sccm | 100 | sccm |
| flow | | | | | | | | | | | | | | |
| rate | | | | | | | | | | | | | | |
| S4 | 100 | Torr | 50 | Torr | 100 | Torr | 200 | Torr | 400 | Torr | 300 | Torr | 200 | Torr |
| cham- | | | | | | | | | | | | | | |
| ber | | | | | | | | | | | | | | |
| air | | | | | | | | | | | | | | |
| pres- | | | | | | | | | | | | | | |
| sure | | | | | | | | | | | | | | |
| S4 RF | 10 | W | 20 | W | 20 | W | 100 | W | 80 | W | 10 | W | 10 | W |
| power | | | | | | | | | | | | | | |

| | Embod- | | Embod- | | Embod- | |
|---|---|---|---|---|---|---|
| | iment | | iment | | iment | |
| | 8 | | 9 | | 10 | |
| Serial | 2 | | 1 | | 3 | |
| number | | | | | | |
| of | | | | | | |
| porous | | | | | | |
| carbon | | | | | | |
| sub- | | | | | | |
| strate | | | | | | |
| ma- | | | | | | |
| terial | | | | | | |
| S1 | 450° C. | | 425° C. | | 400° C. | |
| temper- | | | | | | |
| ature | | | | | | |
| S1 | Silane | | Silane | | Disilane | |
| silicon | (5% | | 100% | | (100%) | |
| source | silane | | | | | |
| | mixed | | | | | |
| | with | | | | | |
| | Ar) | | | | | |
| S1 | 1.5 | h | 1.5 | h | 1.5 | h |
| depo- | | | | | | |
| sition | | | | | | |
| time | | | | | | |
| S1 gas | 400 | sccm | 100 | sccm | 200 | sccm |
| flow | | | | | | |
| rate | | | | | | |
| S1 | 50 | Torr | Ordinary | | 200 | Torr |
| cham- | | | pressure | | | |
| ber | | | | | | |
| air | | | | | | |
| pres- | | | | | | |
| sure | | | | | | |
| S1 RF | 20 | W | — | | 30 | W |
| power | | | | | | |
| S2 | 600° | C. | 550° | C. | 550° | C. |
| temper- | | | | | | |
| ature | | | | | | |
| S2 | Methane | | Acetylene | | Acetylene | |
| carbon | | | | | | |
| source | | | | | | |
| S2 | 0.5 | h | 0.5 | h | 3 | h |
| depo- | | | | | | |
| sition | | | | | | |
| time | | | | | | |
| S2 gas | 200 | sccm | 300 | sccm | 200 | sccm |
| flow | | | | | | |
| rate | | | | | | |
| S2 | 50 | Torr | 100 | Torr | 200 | Torr |
| cham- | | | | | | |
| ber | | | | | | |
| air | | | | | | |
| pres- | | | | | | |
| sure | | | | | | |
| S2 RF | 20 | W | 15 | W | 10 | W |
| power | | | | | | |
| S3 | 550° | C. | 525° | C. | 500° | C. |
| temper- | | | | | | |
| ature | | | | | | |
| S3 | Silane | | Silane | | Silane | |
| silicon | 100% | | 100% | | 100% | |
| source | | | | | | |
| S3 | 2 | h | 3 | h | 0.5 | h |
| depo- | | | | | | |
| sition | | | | | | |
| time | | | | | | |
| S3 gas | 200 | sccm | 300 | sccm | 200 | sccm |
| flow | | | | | | |
| rate | | | | | | |
| S3 | 50 | Torr | 100 | Torr | 10 | Torr |
| cham- | | | | | | |
| ber | | | | | | |
| air | | | | | | |
| pres- | | | | | | |
| sure | | | | | | |
| S3 RF | 15 | W | 10 | W | 20 | W |
| power | | | | | | |
| S4 | 575° | C. | 600° | C. | 575° | C. |
| temper- | | | | | | |
| ature | | | | | | |
| S4 | Methane | | Acetylene | | Acetylene | |
| carbon | | | | | | |
| source | | | | | | |
| S4 | 2 | h | 2 | h | 0.5 | h |
| depo- | | | | | | |
| sition | | | | | | |
| time | | | | | | |
| S4 gas | 200 | sccm | 200 | sccm | 200 | sccm |
| flow | | | | | | |
| rate | | | | | | |
| S4 | 50 | Torr | 100 | Torr | 200 | Torr |
| cham- | | | | | | |
| ber | | | | | | |
| air | | | | | | |
| pres- | | | | | | |
| sure | | | | | | |
| S4 RF | — | | — | | — | |
| power | | | | | | |

### Embodiment 11

(1) A No. 2 carbon material was selected as a porous substrate material.
(2) The carbon material in step (1) was placed in a PECVD reaction chamber; the reaction chamber was repeatedly purged (3-5 times) by using nitrogen; then the nitrogen was turned off, and an argon gas was introduced, with a flow rate being 400 sccm; and then a temperature was risen to 450° C. with a temperature-rising rate being 10° C./min, and the temperature was held for 1 h. 1 h later, the argon was turned off, and a high-purity silane gas was introduced with a flow rate being 400 sccm; a rotary speed of a reaction furnace was controlled at 5 rpm; plasma RF power was 20 W; the pressure of the reaction chamber was 150 Torr; a deposition reaction was performed for 4 h at the temperature; and then the silane gas was turned off, the argon was introduced, and the temperature was cooled to room temperature, so as to obtain a silicon-deposited C/Si material.
(3) 4 g of poly(acrylic acid) was dissolved in 100 g of distilled water, and was fully dissolved at 40° C.; then 200 g of ethanol was added after 2 hours of stirring, and stirring was continuously performed for 0.5 hours; then 90 g of the C/Si material obtained in step (2) was added while stirring; stirring was performed for 2 hours at 60° C., and then the temperature was cooled to room temperature; the material was separated through suction filtration; then the material was placed in a 180° C. drying oven to perform heat treatment for 4 hours; and a C/Si-polymer material was obtained by being taken out after cooling.
(4) The C/Si-polymer material obtained in step (3) was placed in the PECVD reaction chamber; the argon gas was continuously introduced with the flow rate being 400 sccm; and then the temperature was risen to 500° C. with the temperature-rising rate being 10° C./min, and the temperature was held for 1 h. 1 h later, the argon was turned off, and the silane gas was introduced with the flow rate being 100 sccm; the rotary speed of the reaction furnace was controlled at 5 rpm; the RF power was 20 W; the pressure of the reaction chamber was 100 Torr; the deposition reaction was performed for 1 h at the temperature; and then the silane gas was turned off, the argon was introduced, and the temperature was cooled to room temperature, so as to obtain a C/Si-polymer-Si material.
(5) 20 g of the C/Si-polymer-Si material obtained in step (4), 9.5 mL of tetrabutyltitanate, and 95 mL of anhydrous ethanol were well mixed through ball milling. Then 75 mL of deionized water was slowly added dropwise in the well-mixed solution under strong stirring; and a molar ratio n(Ti):n(H₂O) of the tetrabutyltitanate to the distilled water was controlled to be 1:150. A precipitate immediately appeared at room temperature; stirring was continuously performed for 1 h until the reaction ended; and coating powder was separated from the solution, was washed for two times with the deionized water and the anhydrous ethanol, and finally dried at 80° C., so as to obtain TiO₂ coating SiC composite powder. Then ammonia was used as a reducing agent, and nitridation (3 h) was performed on a TiO₂ coating layer at 800° C., so as to finally obtain an anode material of which outermost layer was coated by TiN.

### Embodiment 12

(1) A ZIF-67 Metal Organic Framework (MOF) with porosity being 50%, a specific surface area being 1500 m²/g, a particle size being 1 μm, and an average aperture being 5 nm was selected as a porous substrate material.
(2) The porous substrate material in step (1) was placed in a PECVD reaction chamber; the reaction chamber was repeatedly purged (3-5 times) by using nitrogen; then the nitrogen was turned off, and an argon gas was introduced, with a flow rate being 200 sccm; and then a temperature was risen to 450° C. with a temperature-rising rate being 10° C./min, and the temperature was held for 1 h. 1 h later, the argon was turned off, and a high-purity silane gas was introduced with a flow rate being 400 sccm; a rotary speed of a reaction furnace was controlled at 5 rpm; plasma RF power was 20 W; the pressure of the reaction chamber was 100 Torr; a deposition reaction was performed for 3 h at the temperature; and then the silane gas was turned off, the argon was introduced, and the temperature was cooled to room temperature, so as to obtain a silicon-deposited MOF/Si material.
(3) The MOF/Si material obtained in step (2) and asphalt powder with a particle size being 3 μm were mixed at a mass ratio of 1.3:1, and were mechanically mixed for 10 min by using a VC mixing machine; and then under a nitrogen protection atmosphere, a device was heated to 300° C. while stirring, was held at the temperature for 30 min, and then slowly cooled to room temperature. The material coated by asphalt was held at 400° C. for 2 hours in an argon inert atmosphere, then carbonization was performed for 2 h by rising the temperature to 900° C., and a MOF/Si—C material was obtained after natural cooling.
(4) The MOF/Si—C material obtained in step (3) was placed in the PECVD reaction chamber; the argon gas was continuously introduced with the flow rate being 400 sccm; and then the temperature was risen to 500° C. with the temperature-rising rate being 10° C./min, and the temperature was held for 1 h. 1 h later, the argon was turned off, and the silane gas was introduced with the flow rate being 100 sccm; the rotary speed of the reaction furnace was controlled at 5 rpm; the RF power was 20 W; the pressure of the reaction chamber was 100 Torr; the deposition reaction was performed for 1 h at the temperature; and then the silane gas was turned off, the argon was introduced, and the temperature was cooled to room temperature, so as to obtain a MOF/Si—C—Si material.
(5) The MOF/Si—C—Si material obtained in step (4) was weighed and added in 1000 mL of water, then 20 mL of ethanol was added to obtain precursor suspension, and ultrasound was performed for 2 h; and the precursor suspension dispersed through ultrasound was continuously stirred by using a magnetic stirrer, and nitrogen was continuously introduced into the solution at the same time. Then 1 g of CuSO₄, 10 g of potassium sodium tartrate, 10 g of ethylenediaminetetraacetic acid, and 5 mg of 2,2′-bipyridine were added in the solution, and then sodium hydroxide was added to regulate pH to 10. Then 0.6 g of sodium borohydride was added to 200 mL of water; the sodium hydroxide was added to regulate the pH to 10 and was added dropwise at a speed of about 30 drops/min to the precursor suspension; and finally, a copper-coated anode material was obtained through filtration, addition of a copper protective agent for washing, and vacuum drying.

### Embodiment 13

(1) A No. 3 porous carbon material was selected as a porous substrate material.
(2) The porous carbon material in step (1) was placed in a PECVD reaction chamber; the reaction chamber was repeatedly purged (3-5 times) by using nitrogen; then the nitrogen was turned off, and an argon gas was introduced, with a flow rate being 200 sccm; and then a temperature was risen to 425° C. with a temperature-rising rate being 10° C./min, and the temperature was held for 1 h. 1 h later, the argon was turned off, and a high-purity silane gas was introduced with a flow rate being 200 sccm; a rotary speed of a reaction furnace was controlled at 5 rpm; plasma RF power was 10 W; the pressure of the reaction chamber was 200 Torr; a deposition reaction was performed for 4 h at the temperature; and then the silane gas was turned off, the argon was introduced, and the temperature was cooled to room temperature, so as to obtain a silicon-deposited C/Si material.
(3) 2-methoxyethanol and titanium tetraisopropanolate were mixed at a molar ratio of 4:1 and added to a beaker, and then 160 mL of anhydrous isopropanol was added. The mixed solution was refluxed for 3 h at 82° C., and poured into a volumetric flask for later use, so as to obtain a titanium alkoxide precursor. The C/Si material obtained in step (2) was added to a container, and 160 mL of the anhydrous isopropanol and a proper amount of the deionized water were added. A silicon carbon precursor material was suspended in the solution through magnetic stirring, then the titanium alkoxide precursor well prepared in advance was added dropwise, and the addition of the titanium alkoxide precursor solution was 55 mL and 80 mL, respectively. A pH value was regulated to about 7 through a small amount of ammonia water. Then the mixed solution was heated to 80° C. step by step and refluxed for 2 h, titanium alkoxide underwent hydrolysis and condensation reaction to produce TiO₂; then a solvent was removed at 800° C., and thermal annealing was performed; and a TiO₂ buffer layer was finally formed to obtain a C/Si—TiO₂ material.
(4) The C/Si—TiO₂ material obtained in step (3) was placed in the PECVD reaction chamber; the argon gas was continuously introduced with the flow rate being 300 sccm; and then the temperature was risen to 500° C. with the temperature-rising rate being 10° C./min, and the temperature was held for 1 h. 1 h later, the argon was turned off, and the silane gas was introduced with the flow rate being 200 sccm; the rotary speed of the reaction furnace was controlled at 5 rpm; the RF power was 20 W; the pressure of the reaction chamber was 50 Torr; the deposition reaction was performed for 1 h at the temperature; and then the silane gas was turned off, the argon was introduced, and the temperature was cooled to room temperature, so as to obtain a C/Si—TiO₂—Si material.
(5) The C/Si—TiO₂—Si material obtained in step (4), aluminum nitrate nonahydrate, and a homogenizing-dispersing agent urea were respectively weighed at a molar ratio (100:0.5:8.35), added to 250 mL of the deionized water, and stirred and dispersed uniformly; the obtained dispersed solution was heated to 70° C., and was held at the temperature for 1 h while stirring; an Al(OH)₃-coated precursor was obtained through filtration; and the obtained coating powder was placed in a sintering furnace in an air atmosphere, and was roasted for 5 h at 500° C., so as to obtain an Al₂O₃-coated anode material.

### Embodiment 14

(1) A No. 4 porous carbon material was selected as a porous substrate material.
(2) The porous carbon material in step (1) was placed in a PECVD reaction chamber; the reaction chamber was repeatedly purged (3-5 times) by using nitrogen; then the nitrogen was turned off, and an argon gas was introduced, with a flow rate being 200 sccm; and then a temperature was risen to 425° C. with a temperature-rising rate being 10° C./min, and the temperature was held for 1 h. 1 h later, the argon was turned off, and a high-purity silane gas was introduced with a flow rate being 200 sccm; a rotary speed of a reaction furnace was controlled at 5 rpm; plasma RF power was 10 W; the pressure of the reaction chamber was 200 Torr; a deposition reaction was performed for 4 h at the temperature; and then the silane gas was turned off, the argon was introduced, and the temperature was cooled to room temperature, so as to obtain a silicon-deposited C/Si material.
(3) The C/Si material obtained in step (2) was weighed and added in 1000 mL of water, then 20 ml of ethanol was added to obtain precursor suspension, and ultrasound was performed for 2 h; and the precursor suspension dispersed through ultrasound was continuously stirred by using a magnetic stirrer, and nitrogen was continuously introduced into the solution at the same time. Then 1 g of CuSO₄, 10 g of potassium sodium tartrate, 10 g of ethylenediaminetetraacetic acid, and 5 mg of 2,2′-bipyridine were added in the solution, and then sodium hydroxide was added to regulate pH to 10. Then 0.6 g of sodium borohydride was added to 200 mL of water; the sodium hydroxide was added to regulate the pH to 10, then was added dropwise at a speed of about 30 drops/min to the precursor suspension; and finally, a C/Si—Cu material having a copper buffer layer was obtained through filtration, addition of a copper protective agent for washing, and vacuum drying.
(4) The C/Si—Cu material obtained in step (3) was placed in the PECVD reaction chamber; the argon gas was continuously introduced with the flow rate being 300 sccm; and then the temperature was risen to 500° C. with the temperature-rising rate being 10° C./min, and the temperature was held for 1 h. 1 h later, the argon was turned off, and the silane gas was introduced with the flow rate being 200 sccm; the rotary speed of the reaction furnace was controlled at 5 rpm; the RF power was 20 W; the pressure of the reaction chamber was 50 Torr; the deposition reaction was performed for 1 h at the temperature; and then the silane gas was turned off, the argon was introduced, and the temperature was cooled to room temperature, so as to obtain a C/Si—Cu—Si material.
(5) 5 g of alginic acid was dissolved in 150 g of distilled water, and was fully dissolved and stirred at 60° C.; 3 h later, 200 g of ethanol was added, and stirring was continuously performed for 1.5 h; 100 g of the C/Si—Cu—Si material obtained in step (4) was added under continuous stirring; stirring was continuously performed for 4 h at 35° C., and then the temperature was cooled to room temperature; the material was separated through suction filtration; then the material was placed in a 100° C. drying oven to perform heat treatment for 12 h; and an anode material coated by an alginic acid polymer was obtained by being taken out after cooling.

### Embodiment 15

Differences between this embodiment and Embodiment 1 lied in that, spherical amorphous silicon particles formed through deposition were provided as a first silicon material.

A buffer layer was directly formed on a surface of the first silicon material in step (2), and subsequent steps were the same as Embodiment 1.

The structure of the anode material obtained in this manner was the same as in Embodiment 1 except that there was no porous substrate material.

### Comparative Embodiment 1

(1) A No. 4 porous carbon material was selected as a porous substrate material.
(2) The porous carbon material in step (1) was placed in a PECVD reaction chamber; the reaction chamber was repeatedly purged (3-5 times) by using nitrogen; then the nitrogen was turned off, and an argon gas was introduced, with a flow rate being 400 sccm; and then a temperature was risen to 450° C. with a temperature-rising rate being 10° C./min, and the temperature was held for 1 h. 1 h later, the argon was turned off, and a high-purity silane gas was introduced with a flow rate being 400 sccm; a rotary speed of a reaction furnace was controlled at 5 rpm; plasma RF power was 20 W; the pressure of the reaction chamber was 150 Torr; a deposition reaction was performed for 4 h at the temperature; and then the silane gas was turned off, the argon was introduced, and the temperature was cooled to room temperature, so as to obtain a silicon-deposited C/Si material.
(3) The C/Si material was placed in a CVD reaction chamber again; the reaction chamber was repeatedly purged (3-5 times) by using nitrogen; then the nitrogen was turned off, and an argon gas was introduced, with a flow rate being 400 sccm; and then a temperature was risen to 600° C. with a temperature-rising rate being 10° C./min, and the temperature was held for 1 h. 1 h later, the argon was turned off, and an ethylene gas was introduced with a flow rate being 200 sccm; the rotary speed of the reaction furnace was controlled at 5 rpm; the pressure of the reaction chamber was an ordinary pressure; the deposition reaction was performed for 4 h at the temperature; and then the ethylene gas was turned off, the argon was introduced, and the temperature was cooled to room temperature, so as to obtain an anode material coated by silicon deposited carbon on a carbon framework.

The anode material prepared in this manner had a structure with three layers in total, and only included a porous substrate material, a silicon material layer, and a coating layer.

### Comparative Embodiment 2

(1) A No. 1 porous carbon material was selected as a porous substrate material.
(2) The porous carbon material in step (1) was placed in a reaction chamber; the reaction chamber was repeatedly purged (3-5 times) by using nitrogen; then the nitrogen was turned off, and an argon gas was introduced, with a flow rate being 400 sccm; and then a temperature was risen to 650° C. with a temperature-rising rate being 10° C./min, and the temperature was held for 1 h. 1 h later, the argon was turned off, and a high-purity silane gas (99.9999%) was introduced with a flow rate being 50 sccm; a rotary speed of a reaction furnace was controlled at 5 rpm; the pressure of the reaction chamber was 0.1 Torr; a deposition reaction was performed for 6 h at the temperature; and then the silane gas was turned off, the argon was introduced, and the temperature was cooled to room temperature, so as to obtain a silicon-deposited C/Si material layer.
(3) After the reaction chamber in step (2) was cooled to room temperature, the argon was maintained to be introduced, then the temperature was risen to 650° C. with a temperature-rising rate being 10° C./min, and the temperature was held for 1 h. 1 h later, the argon was turned off, and a methane gas was introduced with a flow rate being 300 sccm; the rotary speed of the reaction furnace was controlled at 5 rpm; RF power was 10 W; the pressure of the reaction chamber was 0.1 Torr; the deposition reaction was performed for 0.5 h at the temperature; and then the methane gas was turned off, the argon was introduced, and the temperature was cooled to room temperature, so as to obtain a double-layer deposited C/Si—C material).
(4) After the reaction chamber in step (3) was cooled to room temperature, the argon gas was continuously introduced with a flow rate being 200 sccm, then the temperature was risen to 450° C. with a temperature-rising rate being 10° C./min, and the temperature was held for 1 h. 1 h later, the argon was turned off, and the silane gas was introduced with the flow rate being 50 sccm; the rotary speed of the reaction furnace was controlled at 5 rpm; the pressure of the reaction chamber was 0.1 Torr; the deposition reaction was performed for 6 h at the temperature; and then the silane gas was turned off, the argon was introduced, and the temperature was cooled to room temperature, so as to obtain a three-layer deposited C/Si—C—Si material.
(5) After the reaction chamber in step (4) was cooled to room temperature, the argon gas was continuously introduced with a flow rate being 400 sccm, then the temperature was risen to 800° C. with a temperature-rising rate being 10° C./min, and the temperature was held for 1 h. 1 h later, the argon was turned off, and the methane gas was introduced with the flow rate being 200 sccm; the rotary speed of the reaction furnace was controlled at 5 rpm; the pressure of the reaction chamber was an ordinary pressure; the deposition reaction was performed for 2 h at the temperature; and then the methane gas was turned off, the argon was introduced, and the temperature was cooled to room temperature, so as to obtain a four-layer deposited anode material (C/Si—C—Si@C material).

In this manner, a high carbon coating temperature (800° C.) led to the disappearance of some pores in a microstructure of the anode material, such that the capability of the anode material in relieving changes in volume during charging and discharging was weakened. Furthermore, when the material was treated at a high temperature, the amorphous silicon material was crystallized into a crystalline silicon material, making electrochemical performance worse. In addition, a two-phase region formed during a reaction between silicon and lithium due to the crystallization of silicon, resulting in uneven volume changes, and thus affecting subsequent cycle performance.

### Comparative Embodiment 3

Compared with Embodiment 1, original step (3) was omitted, i.e., the buffer layer was not formed, and other steps were the same as Embodiment 1.

The anode material having the first silicon material layer, the second silicon material layer, and the coating layer, which are sequentially formed on the porous substrate material, was obtained.

Physical performance and electrochemical performance testing were performed on the anode material obtained in the embodiments and comparative embodiments. A test method was as follows.

### Test Method

1. Tap density:

Certain mass of a sample to be tested was placed in a measuring cylinder, vibration was performed as many times as required (routine test with 3000 cycles of vibration), the volume of the measuring cylinder after vibration was read, and a tap density was calculated.
2. Density of the silicon material layer:

The coating layer, the second silicon material layer, the buffer layer, and the first silicon material layer were striped in layers by means of ion milling, the densities of the first silicon material layer and the second silicon material layer were respectively measured by using a helium specific gravity method.
3. Hydrogen content in the silicon layer: chemical element analysis and determination was performed by using CHNO gas chromatography.
4. Thicknesses of the silicon layer, the buffer layer, and the coating layer: the thicknesses of different layers might be obtained through Scanning Electron Microscope (SEM)/Transmission Electron Microscope (TEM) image testing analysis.
5. The type of silicon in the silicon layer: the type of silicon was determined by using X-Ray Diffraction (XRD).
6. Filling rate testing:

The porosity M1 of the anode material was tested; the coating layer, the second silicon material layer, the buffer layer, and the first silicon material layer were striped in layers by means of ion milling; and then the porosity M2 of the porous conductive material was tested, filling rate=(M2−M1)/M2*100%.
7. Electrical performance testing:

The anode material was mixed with sodium carboxymethyl cellulose, styrene-butadiene rubber, conductive graphite (KS-6), and carbon black (SP) respectively in a ratio of 92:2:2:2:2, so as to prepare slurry, the mixture was uniformly coated on copper foil and dried to prepare into an anode plate; a button battery was assembled in an argon atmosphere glove box; a diaphragm used was a polypropylene microporous membrane; an electrolyte solution used was 1 mol/L of lithium hexafluorophosphate (a solvent being mixed slurry of ethylene carbonate, ethyl methyl carbonate, and dimethyl carbonate); and a counter electrode used was a metallic lithium sheet.

A battery was prepared by the silicon carbon composite material prepared by the embodiments and comparative embodiments; specific discharge capacity testing was performed on a blue lightning CT2001A battery testing system; and a ratio of the discharge capacity in 1 hour to the battery capacity is the specific discharge capacity.

The battery was prepared by the silicon carbon composite material prepared by the embodiments and comparative embodiments; first coulombic efficiency testing was performed on the blue lightning CT2001A battery testing system; and a charging and discharging current was 0.05 C, and first coulombic efficiency was measured.

The battery was prepared by the silicon carbon composite material prepared by the embodiments and comparative embodiments; 100 cycle testing was performed on the blue lightning CT2001A battery testing system; and the charging and discharging current was 0.2 C, and the post-cycle battery capacity and the post-cycle capacity retention were tested and calculated after 100 cycles.

0.2 C capacity retention after 100 cycles=discharging capacity of the 100th cycle/first week discharging capacity*100%, and the tested value was an average value of 3-5 button batteries of each material.

Test results were shown in Table 3 and Table 4.

TABLE 3
Physical performance of anode material

| | | | Den- | Hydro- | | | Den - | Hy- | | | |
|---|---|---|---|---|---|---|---|---|---|---|---|
| | | | sity | gen | | | sity | drogen | Thick- | | |
| | | | of | con- | Thick- | Thick- | of | content | ness | Thick- | |
| | | | first | tent | ness | ness | second | of | of | ness | |
| | Type of | Tap | sili- | of | of | of | sili- | second | second | of | |
| | first/ | den- | con | first | first | buf- | con | sili- | sili- | coat- | Fill- |
| | second | sity | layer | silicon | silicon | fer | layer | con | con | ing | ing |
| | material | (g/c | (g/c | layer | layer | layer | (g/c | layer | layer | layer | rate |
| | layer | m³) | m³) | (%) | (nm) | (nm) | m³) | (%) | (nm) | (nm) | (%) |
| Embod- | Amorphous | 0.9 | 1.91 | 9.5 | 493 | 412 | 2.21 | 3.5 | 166 | 101 | 70 |
| iment 1 | silicon/ | | | | | | | | | | |
| | amorphous | | | | | | | | | | |
| | silicon | | | | | | | | | | |
| Embod- | Amorphous | 0.9 | 1.93 | 9.1 | 502 | 398 | 2.19 | 4.2 | 157 | 110 | 74 |
| iment 2 | silicon/ | | | | | | | | | | |
| | amorphous | | | | | | | | | | |
| | silicon | | | | | | | | | | |
| Embod- | Crystalline | 1.0 | 1.91 | 9.5 | 550 | 405 | 2.20 | 4.0 | 163 | 121 | 51 |
| iment 3 | silicon/ | | | | | | | | | | |
| | crystalline | | | | | | | | | | |
| | silicon | | | | | | | | | | |
| Embod- | Amorphous | 1.05 | 2.01 | 8.2 | 513 | 389 | 2.23 | 4.2 | 153 | 135 | 76 |
| iment 4 | silicon/ | | | | | | | | | | |
| | amorphous | | | | | | | | | | |
| | silicon | | | | | | | | | | |
| Embod- | Amorphous | 1.1 | 2.09 | 7.1 | 488 | 385 | 2.19 | 3.8 | 166 | 100 | 69 |
| iment 5 | silicon/ | | | | | | | | | | |
| | amorphous | | | | | | | | | | |
| | silicon | | | | | | | | | | |
| Embod- | Amorphous | 0.88 | 1.95 | 8.7 | 484 | 401 | 2.14 | 6.9 | 149 | 195 | 79 |
| iment 6 | silicon/ | | | | | | | | | | |
| | amorphous | | | | | | | | | | |
| | silicon | | | | | | | | | | |
| Embod- | Amorphous | 0.81 | 1.93 | 9.1 | 504 | 399 | 2.11 | 7.3 | 150 | 200 | 70 |
| iment 7 | silicon/ | | | | | | | | | | |
| | amorphous | | | | | | | | | | |
| | silicon | | | | | | | | | | |
| Embod- | Amorphous | 0.92 | 1.92 | 9.5 | 255 | 386 | 2.22 | 3.4 | 151 | 105 | 76 |
| iment 8 | silicon/ | | | | | | | | | | |
| | amorphous | | | | | | | | | | |
| | silicon | | | | | | | | | | |
| Embod- | Amorphous | 0.88 | 1.91 | 9.5 | 499 | 418 | 2.28 | 3.1 | 242 | 124 | 74 |
| iment 9 | silicon/ | | | | | | | | | | |
| | amorphous | | | | | | | | | | |
| | silicon | | | | | | | | | | |
| Embod- | Amorphous | 0.89 | 1.94 | 8.9 | 504 | 809 | 2.27 | 4.5 | 152 | 122 | 54 |
| iment 10 | silicon/ | | | | | | | | | | |
| | amorphous | | | | | | | | | | |
| | silicon | | | | | | | | | | |
| Embod- | Crystalline | 1.13 | 1.92 | 9.0 | 496 | 179 | 2.21 | 3.5 | 155 | 95 | 75 |
| iment 11 | silicon/ | | | | | | | | | | |
| | crystalline | | | | | | | | | | |
| | silicon | | | | | | | | | | |
| Embod- | Crystalline | 1.07 | 1.91 | 9.1 | 489 | 400 | 2.23 | 3.2 | 149 | 111 | 69 |
| iment 12 | silicon/ | | | | | | | | | | |
| | crystalline | | | | | | | | | | |
| | silicon | | | | | | | | | | |
| Embod- | Crystalline | 1.21 | 1.93 | 8.9 | 504 | 188 | 2.27 | 3.7 | 158 | 78 | 53 |
| iment 13 | silicon/ | | | | | | | | | | |
| | crystalline | | | | | | | | | | |
| | silicon | | | | | | | | | | |
| Embod- | Amorphous | 1.24 | 1.94 | 7.1 | 512 | 200 | 2.19 | 3.9 | 152 | 80 | 72 |
| iment 14 | silicon/ | | | | | | | | | | |
| | amorphous | | | | | | | | | | |
| | silicon | | | | | | | | | | |
| Embod- | Amorphous | 0.91 | 1.90 | 9.4 | 495 | 412 | 2.21 | 3.4 | 168 | 102 | — |
| iment 15 | silicon/ | | | | | | | | | | |
| | amorphous | | | | | | | | | | |
| | silicon | | | | | | | | | | |
| Compar- | Amorphous | 0.82 | 1.91 | 9.5 | 691 | 0 | — | — | 0 | 527 | 70 |
| ative | silicon/ | | | | | | | | | | |
| embod- | amorphous | | | | | | | | | | |
| iment 1 | silicon | | | | | | | | | | |
| Compar- | Crystalline | 0.95 | 2.17 | 3.2 | 488 | 403 | 2.01 | 3.7 | 160 | 110 | 73 |
| ative | silicon/ | | | | | | | | | | |
| embod- | crystalline | | | | | | | | | | |
| iment 2 | silicon | | | | | | | | | | |
| Compar- | Amorphous | 1.05 | 1.92 | 9.4 | 491 | — | 2.20 | 3.5 | 167 | 103 | 71 |
| ative | silicon/ | | | | | | | | | | |
| Embod- | amorphous | | | | | | | | | | |
| iment 3 | silicon | | | | | | | | | | |

TABLE 4
Electrical performance of anode material

| | First | | | | Electrode |
|---|---|---|---|---|---|
| | reversible | First | 0.2 C capacity | 0.2 C capacity | plate |
| | capacity | coulombic | after 100 cycles | retention after | expansion |
| | (mAh/g) | efficiency (%) | (mAh/g) | 100 cycles (%) | rate (%) |
| Embodiment 1 | 2074 | 89.1 | 1668 | 85.0 | 23.4 |
| Embodiment 2 | 1980 | 86.6 | 1532 | 82.4 | 24.7 |
| Embodiment 3 | 2050 | 87.7 | 1412 | 72.5 | 28.6 |
| Embodiment 4 | 2003 | 87.6 | 1579 | 83.2 | 25.5 |
| Embodiment 5 | 1982 | 83.4 | 1598 | 82.5 | 26.4 |
| Embodiment 6 | 1997 | 84.5 | 1542 | 81.3 | 26.8 |
| Embodiment 7 | 2122 | 82.3 | 1568 | 76.5 | 27.1 |
| Embodiment 8 | 1607 | 87.9 | 1267 | 81.3 | 24.1 |
| Embodiment 9 | 2153 | 86.2 | 1583 | 77 | 29.3 |
| Embodiment 10 | 1862 | 84.7 | 1399 | 78.3 | 26.1 |
| Embodiment 11 | 1538 | 85.2 | 1118 | 74 | 31.2 |
| Embodiment 12 | 1477 | 87.6 | 1017 | 72 | 32.6 |
| Embodiment 13 | 1302 | 81.5 | 907 | 70 | 31.7 |
| Embodiment 14 | 1568 | 86.2 | 1133 | 67 | 32.1 |
| Embodiment 15 | 2207 | 89.3 | 1333 | 65 | 35.7 |
| Comparative | 1860 | 78.7 | 1167 | 60 | 41 |
| embodiment 1 | | | | | |
| Comparative | 1822 | 75.6 | 1008 | 55.5 | 39.6 |
| embodiment 2 | | | | | |
| Comparative | 1326 | 85.0 | 1152 | 56.8 | 45.8 |
| embodiment 3 | | | | | |

According to Tables 3 and 4, it might be learned that, Embodiments 1-10 were all silicon carbon composite materials prepared by using the vapor deposition method; when the deposition temperature was high, the crystalline silicon deposition layer was obtained; when the deposition temperature was low, the amorphous silicon deposition layer was obtained; and the buffer layer and the coating layer both were amorphous carbon. In the silicon carbon composite materials obtained Embodiments 11-14, the porous substrate material was a metal organic framework or porous carbon; the buffer layer was amorphous carbon, a polymer, TiO₂, or copper; and the coating layer was TiO₂, copper, Al₂O₃, or a polymer. The cycle retention of Embodiments 1-14 was high, and the electrode plate expansion rate was low.

In Embodiment 15, the buffer layer, the second silicon material layer, and the coating layer were directly formed through deposition on surfaces of spherical amorphous silicon particles (first silicon material); the first reversible capacity of the anode material was significantly increased; and due to the increase of the content of the silicon component, the electrode plate expansion rate was slightly increased compared with Embodiment 1.

There were only one silicon material layer and one buffer layer (amorphous carbon layer) in Comparative embodiment 1, and the electrode plate expansion rate reached 41%.

In Comparative embodiment 2, although there was a multilayer structure, the density of the first silicon material layer was higher than that of the second silicon material layer, such that the cycle retention was poor, and the electrode plate expansion rate was high.

The buffer layer was not included in Comparative embodiment 3, large volume expansion occurred in the high-load silicon material during lithium intercalation, the absence of the buffer layer coped with stress changes during volume changes, an electrode active material was susceptible to fracture and pulverization during cycling, triggering capacity degradation, such that the capacity retention after cycling was low, and the electrode plate expansion rate was high.

To sum up, the present disclosure provided the anode material that might be applied to a lithium-ion secondary battery. The anode material included the porous substrate material. The fluffy first silicon material layer, the buffer layer, the dense second silicon material layer, and the coating layer were sequentially formed on the at least partial surface of the porous substrate material. Therefore, the conductivity of the material was improved, and the expansion efficiency of the silicon material might be effectively relieved as well. Through the design of the multilayer structure, the performance of the material was optimized, and the structural integrity of the material during cycling was improved.

Further, in the present disclosure, by means of the anode material obtained by preparing the silicon material layer by means of vapor deposition, the capacity of the silicon material might be increased, and the thickness and density of the silicon material layer were controlled more easily.

The above descriptions were merely the implementations of the present disclosure, and were not intended to limit the scope of the present disclosure. Any equivalent structure or equivalent process transformation using the contents of the specification of the present disclosure and the drawings, or directly or indirectly applying them in other related technical fields, were similarly included in the scope of patent protection of the present disclosure.

1. An anode material, the anode material comprises:
a first silicon material layer; and
a buffer layer, a second silicon material layer, and a coating layer, which are sequentially arranged on a surface of the first silicon material layer, wherein
wherein, the density of the first silicon material layer is less than the density of the second silicon material layer.

2. The anode material according to claim 1, wherein, the anode material further comprises:
a porous substrate material, wherein the first silicon material layer is located on a surface of the porous substrate material, and the buffer layer, the second silicon material layer, and the coating layer are sequentially arranged on the surface of the first silicon material layer.

3. The anode material according to claim 1, wherein, the anode material comprises at least one of the following features (1)-(10):
(1) the density of the first silicon material layer is 1.9 g/cm³-2.1 g/cm³;
(2) the density of the second silicon material layer is 2.1 g/cm³-2.3 g/cm³;
(3) the thickness of the first silicon material layer is 20%-40% of a total thickness of the first silicon material layer, the buffer layer, the second silicon material layer, and the coating layer;
(4) the thickness of the second silicon material layer is 10%-20% of a total thickness of the first silicon material layer, the buffer layer, the second silicon material layer, and the coating layer;
(5) the thickness of the buffer layer is 20%-40% of a total thickness of the first silicon material layer, the buffer layer, the second silicon material layer, and the coating layer;
(6) the thickness of the coating layer is 10%-20% of a total thickness of the first silicon material layer, the buffer layer, the second silicon material layer, and the coating layer;
(7) the thickness of the first silicon material layer is 0.01 μm-5 μm;
(8) the thickness of the second silicon material layer is 0.01 μm-1 μm;
(9) the thickness of the buffer layer is 0.01 μm-5 μm; and
(10) the thickness of the coating layer is 0.01 μm-1 μm.

4. The anode material according to claim 1, wherein, the anode material comprises at least one of the following features (1)-(16):
(1) the mass of silicon in the first silicon material layer accounts for 90.00%-99.99% of the mass of the first silicon material layer;
(2) the mass of hydrogen in the first silicon material layer accounts for 0.01%-10% of the mass of the first silicon material layer;
(3) the mass of silicon in the second silicon material layer accounts for 90.00%-99.99% of the mass of the second silicon material layer;
(4) the mass of hydrogen in the second silicon material layer accounts for 0.01%-10% of the mass of the second silicon material layer;
(5) the first silicon material layer comprises at least one of amorphous silicon or crystalline silicon;
(6) the buffer layer comprises amorphous carbon;
(7) the buffer layer comprises a metallic oxide, and the metallic oxide comprises at least one of titanium oxide, silicon oxide, and aluminum oxide;
(8) the buffer layer comprises metal, and the metal comprises at least one of tin and copper;
(9) the buffer layer comprises a nitride, and the nitride comprises at least one of silicon nitride, aluminum nitride, titanium nitride, and tantalum nitride;
(10) the buffer layer comprises a flexible polymer, and the flexible polymer comprises at least one of polyolefin and derivatives thereof, poly(vinyl alcohol) and derivatives thereof, poly(acrylic acid) and derivatives thereof, polyamide and derivatives thereof, carboxymethyl cellulose and derivatives thereof, and alginic acid and derivatives thereof;
(11) the second silicon material layer comprises at least one of amorphous silicon and crystalline silicon;
(12) the coating layer comprises amorphous carbon;
(13) the coating layer comprises a metallic oxide, and the metallic oxide comprises at least one of titanium oxide, silicon oxide, and aluminum oxide;
(14) the coating layer comprises metal, and the metal comprises at least one of tin and copper;
(15) the coating layer comprises a nitride, and the nitride comprises at least one of silicon nitride, aluminum nitride, titanium nitride, and tantalum nitride; or
(16) the coating layer comprises a flexible polymer, and the polymer comprises at least one of polyolefin and derivatives thereof, poly(vinyl alcohol) and derivatives thereof, poly(acrylic acid) and derivatives thereof, polyamide and derivatives thereof, carboxymethyl cellulose and derivatives thereof, and alginic acid and derivatives thereof.

5. The anode material according to claim 1, wherein, the anode material comprises at least one of the following features (1)-(5):
(1) the first silicon material layer is provided with pores;
(2) the first silicon material layer is provided with pores, and the porosity of the first silicon material layer is 1%-40%;
(3) the first silicon material layer is provided with pores, and the pores of the first silicon material layer have an aperture size being 5 nm-100 nm;
(4) the first silicon material layer is provided with pores, and the first silicon material layer has a pore volume being 0.01 cm³/g-0.5 cm³/g; or
(5) at least partial buffer layer material in the buffer layer is filled in the pores of the first silicon material layer.

6. The anode material according to claim 2, wherein, the porous substrate material comprises at least one of the following features (1)-(9):
(1) the porosity of the porous substrate material is 40%-60%;
(2) the specific surface area of the porous substrate material is 5 m²/g-2500 m²/g;
(3) the particle size of the porous substrate material is 5 μm-20 μm;
(4) the aperture size of the porous substrate material is 5 nm-100 nm;
(5) the pore capacity of the porous substrate material is 0.01 cm³/g-1.8 cm³/g;
(6) the porous substrate material comprises at least one of porous carbon and a porous organic framework;
(7) the porous substrate material is a conductive material;
(8) at least part of the first silicon material layer is filled in a pore structure of the porous substrate material; and
(9) a filling rate of the pore structure of the porous substrate material is 40%-80%.

7. The anode material according to claim 1, wherein, the porous substrate material comprises at least one of the following features (1)-(6):
(1) the anode material is provided with a pore structure;
(2) the anode material is provided with the pore structure, and the pore structure comprises micropores, mesopores and macropores;
(3) the anode material is provided with the pore structure, and the pore structure comprises the micropores, the mesopores and the macropores, wherein a volume proportion of the micropores in the pore structure is greater than 70%, a volume proportion of the mesopores in the pore structure is greater than 20%, and a volume proportion of the macropores in the pore structure is less than 10%;
(4) the anode material is provided with the pore structure, and the pore structure has a pore volume being 0.001 cm³/g-0.1 cm³/g;
(5) the tap density of the anode material is 0.5 cm³/g-1.5 cm³/g; or
(6) the specific surface area of the anode material is 5 m²/g-30 m²/g.

8. A method for preparing an anode material, comprising the following steps:
providing a first silicon material layer;
forming a buffer layer on at least partial surface of the first silicon material layer;
forming a second silicon material layer on at least partial surface of the buffer layer; and
forming a coating layer on at least partial surface of the second silicon material layer, wherein
the density of the first silicon material layer is less than the density of the second silicon material layer.

9. The method for preparing an anode material according to claim 8, comprising the following steps:
providing a porous substrate material, and forming a first silicon material layer on at least partial surface of the porous substrate material;
forming a buffer layer on at least partial surface of the first silicon material layer;
forming a second silicon material layer on at least partial surface of the buffer layer; and
forming a coating layer on at least partial surface of the second silicon material layer, wherein
the density of the first silicon material layer is less than the density of the second silicon material layer.

10. The preparation method according to claim 8, wherein at least one of the first silicon material layer, the buffer layer, the second silicon material layer, and the coating layer is formed by using a vapor deposition method.

11. The preparation method according to claim 8, wherein, the preparation method comprises at least one of the following features (1)-(13):
(1) a deposition temperature for forming the first silicon material layer formed by using the vapor deposition method is less than a deposition temperature for forming the second silicon material layer;
(2) the deposition temperature for forming the first silicon material layer and the second silicon material layer by using the vapor deposition method is 400° C.-800° C.;
(3) deposition time for forming the first silicon material layer and the second silicon material layer by using the vapor deposition method is 2 h-6 h;
(4) the step of forming the first silicon material layer and the second silicon material layer by using the vapor deposition method further comprises introducing a gas phase silicon source;
(5) the step of forming the first silicon material layer and the second silicon material layer by using the vapor deposition method further comprises introducing the gas phase silicon source, wherein a total flow rate of the gas phase silicon source is 100 sccm-500 sccm;
(6) the step of forming the first silicon material layer and the second silicon material layer by using the vapor deposition method further comprises introducing the gas phase silicon source and an inert carrier gas;
(7) the step of forming the first silicon material layer and the second silicon material layer by using the vapor deposition method further comprises introducing the gas phase silicon source and the inert carrier gas, wherein the inert carrier gas comprises at least one of nitrogen, argon, and helium;
(8) the step of forming the first silicon material layer and the second silicon material layer by using the vapor deposition method further comprises introducing the gas phase silicon source and the inert carrier gas, wherein a total flow rate of the gas phase silicon source and the inert carrier gas is 100 sccm-500 sccm;
(9) the step of forming the first silicon material layer and the second silicon material layer by using the vapor deposition method further comprises introducing the gas phase silicon source and the inert carrier gas, wherein a volume proportion of the gas phase silicon source in a gas is 5%-100%;
(10) the step of forming the first silicon material layer by using the vapor deposition method further comprises introducing a dopant gas;
(11) the step of forming the first silicon material layer by using the vapor deposition method further comprises introducing the dopant gas, wherein the dopant gas is NH₃ or PH₃;
(12) the step of forming the first silicon material layer and the second silicon material layer by using the vapor deposition method further comprises introducing the gas phase silicon source and the inert carrier gas, wherein the gas phase silicon source comprises at least one of silane, disilane, trisilane, and tetrasilane; and
(13) the step of forming the first silicon material layer and the second silicon material layer by using the vapor deposition method specifically comprises using plasma to enhance the vapor deposition method for vapor deposition.

12. The preparation method according to claim 8, wherein, the preparation method further comprises at least one of the following features (1)-(21):
(1) a deposition temperature for forming the buffer layer by using the vapor deposition method is 450° C.-800° C.;
(2) deposition time for forming the buffer layer by using the vapor deposition method is 0.5 h-3 h;
(3) the step of forming the buffer layer by using the vapor deposition method further comprises introducing a gas phase carbon source;
(4) the step of forming the buffer layer by using the vapor deposition method further comprises introducing the gas phase carbon source, wherein a total flow rate of the gas phase carbon source is 100 sccm-500 sccm;
(5) the step of forming the buffer layer by using the vapor deposition method further comprises introducing the gas phase carbon source and an inert carrier gas;
(6) the step of forming the buffer layer by using the vapor deposition method further comprises introducing the gas phase carbon source and the inert carrier gas, wherein the inert carrier gas comprises at least one of nitrogen, argon, and helium;
(7) the step of forming the buffer layer by using the vapor deposition method further comprises introducing the gas phase carbon source and the inert carrier gas, wherein a total flow rate of the gas phase carbon source and the inert carrier gas is 100 sccm-500 sccm;
(8) the step of forming the buffer layer by using the vapor deposition method further comprises introducing the gas phase carbon source and the inert carrier gas, wherein a volume ratio of the gas phase carbon source to the inert carrier gas is 1:(1-10);
(9) the step of forming the buffer layer by using the vapor deposition method further comprises introducing the gas phase carbon source and the inert carrier gas, wherein the gas phase carbon source comprises any one or a combination of at least two of methane, ethane, propane, ethylene, acetylene, gaseous benzene, gaseous toluene, gaseous xylene, gaseous ethanol, and gaseous acetone;
(10) the step of forming the buffer layer by using the vapor deposition method further comprises filling at least partial carbon material formed through the cracking of the gas phase carbon source in pores of the first silicon material layer;
(11) a deposition temperature for forming the coating layer by using the vapor deposition method is 400° C.-800° C.;
(12) deposition time for forming the coating layer by using the vapor deposition method is 0.5 h-3 h;
(13) the step of forming the coating layer by using the vapor deposition method further comprises introducing a gas phase carbon source;
(14) the step of forming the coating layer by using the vapor deposition method further comprises introducing the gas phase carbon source, wherein a total flow rate of the gas phase carbon source is 100 sccm-500 sccm;
(15) the step of forming the coating layer by using the vapor deposition method further comprises introducing the gas phase carbon source and an inert carrier gas;
(16) the step of forming the coating layer by using the vapor deposition method further comprises introducing the gas phase carbon source and the inert carrier gas, wherein the inert carrier gas comprises at least one of nitrogen, argon, and helium;
(17) the step of forming the coating layer by using the vapor deposition method further comprises introducing the gas phase carbon source and the inert carrier gas, wherein a total flow rate of the gas phase carbon source and the inert carrier gas is 100 sccm-500 sccm;
(18) the step of forming the coating layer by using the vapor deposition method further comprises introducing the gas phase carbon source and the inert carrier gas, wherein a volume ratio of the gas phase carbon source to the inert carrier gas is 1:(1-10);
(19) the step of forming the coating layer by using the vapor deposition method further comprises introducing the gas phase carbon source and the inert carrier gas, wherein the gas phase carbon source comprises any one or a combination of at least two of methane, ethane, propane, ethylene, acetylene, gaseous benzene, gaseous toluene, gaseous xylene, gaseous ethanol, and gaseous acetone;
(20) the step of forming the coating layer by using the vapor deposition method further comprises filling at least partial carbon material formed through the cracking of the gas phase carbon source in pores of the second silicon material layer; or
(21) the step of forming the buffer layer and the coating layer by using the vapor deposition method specifically comprises using plasma to enhance the vapor deposition method for vapor deposition.

13. The preparation method according to claim 8, wherein a first silicon material and a buffer layer raw material are mixed in a solvent, and then drying and curing are performed to form the buffer layer on the at least partial surface of the first silicon material layer.

14. The preparation method according to claim 9, wherein a substance after the first silicon material layer is formed and a buffer layer raw material are mixed in a solvent, and then drying and curing are performed to form the buffer layer on the at least partial surface of the first silicon material layer.

15. The preparation method according to claim 13, wherein the preparation method comprises at least one of the following features (1)-(7):
(1) the buffer layer raw material comprises at least one of a carbon material, a metallic oxide, a conductive polymer material, and a nitride;
(2) the buffer layer raw material comprises the carbon material, and the carbon material comprises at least one of soft carbon, hard carbon, crystalline carbon, and amorphous carbon;
(3) the buffer layer raw material comprises the metallic oxide, and the metallic oxide comprises at least one of titanium oxide, aluminum oxide, lithium oxide, cobalt oxide, and vanadium oxide;
(4) the buffer layer raw material comprises a conductive polymer, and the conductive polymer comprises at least one of polyaniline, polyacetylene, polypyrrole, polythiophene, poly(3-hexylthiophene), poly(para-styrene), polypyridine, and poly(phenylene ethylene);
(5) the buffer layer raw material comprises the nitride, and the nitride comprises at least one of titanium nitride, vanadium nitride, cobalt nitride, nickel nitride, and carbon nitride;
(6) a temperature of drying and curing is 80° C.-150° C., and temperature-holding time for drying and curing is 1 h-12 h; and
(7) after the substance after the first silicon material layer is formed and the buffer layer raw material are mixed in the solvent, and then drying and curing are performed, the method further comprises performing heat treatment on dried and cured products, wherein a temperature of the heat treatment is 400° C.-900° C., and temperature-holding time for the heat treatment is 1 h-12 h.

16. The preparation method according to claim 8, wherein a substance after the second silicon material layer is formed and a coating layer raw material are mixed in a solvent, and then drying and curing are performed to form the coating layer on the at least partial surface of the second silicon material layer.

17. The preparation method according to claim 16, wherein the preparation method comprises at least one of the following features (1)-(7):
(1) the coating layer raw material comprises at least one of a carbon material, a metallic oxide, a conductive polymer material, and a nitride;
(2) the coating layer raw material comprises the carbon material, and the carbon material comprises at least one of soft carbon, hard carbon, crystalline carbon, and amorphous carbon;
(3) the coating layer raw material comprises the metallic oxide, and the metallic oxide comprises at least one of titanium oxide, aluminum oxide, lithium oxide, cobalt oxide, and vanadium oxide;
(4) the coating layer raw material comprises a conductive polymer, and the conductive polymer comprises at least one of polyaniline, polyacetylene, polypyrrole, polythiophene, poly(3-hexylthiophene), poly(para-styrene), polypyridine, and poly(phenylene ethylene);
(5) the coating layer raw material comprises the nitride, and the nitride comprises at least one of titanium nitride, vanadium nitride, cobalt nitride, nickel nitride, and carbon nitride;
(6) a temperature of drying and curing is 80° C.-150° C., and temperature-holding time for drying and curing is 1 h-12 h; and
(7) after the substance after the second silicon material layer is formed and the coating layer raw material are mixed in the solvent, and then drying and curing are performed, the method further comprises performing heat treatment on dried and cured products, wherein a temperature of the heat treatment is 400° C.-900° C., and temperature-holding time for the heat treatment is 1 h-12 h.

18. A battery, comprising the anode material according to claim 1.

19. A battery, comprising the anode material obtained by the preparation method according claim 8.
